(19) United States
(12) Patent Application Publication
(10) Pub. No.: US 2009/0214768 A1
(43) Pub. Date: Aug. 27, 2009

(54) PROCESS FOR PRODUCING MAGNETIC RECORDING MEDIUM

(75) Inventors: Tomohiro ICHIKAWA, Kanagawa (JP); Hirotaka Sato, Kanagawa (JP); Masahiko Mori, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/388,246

(22) Filed: Feb. 18, 2009

(30) Foreign Application Priority Data
Feb. 27, 2008 (JP) 2008-045835

(51) Int. Cl. G11B 5/84

(52) U.S. Cl. 427/131

(57) ABSTRACT

A process for producing a magnetic recording medium is provided, the process comprising in sequence a step of forming a non-magnetic layer by applying a non-magnetic coating liquid above a non-magnetic support, a step of curing the non-magnetic layer by irradiation with radiation, and a step of forming a magnetic layer above the cured non-magnetic layer, the non-magnetic coating liquid comprising a resin having a hydroxy group and/or an amino group and a compound having an isocyanato group and/or a substituent represented by Formula (1) below and a radiation curing functional group.

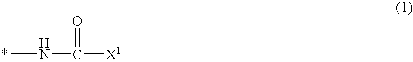

(In Formula (1) above, X¹ is Formula (2) or Formula (3) below, and * denotes a bonding position).

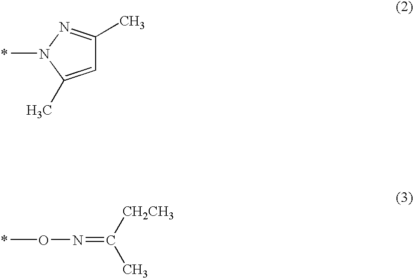

### BACKGROUND OF THE INVENTION

1. Field of the Invention

The present invention relates to a process for producing a magnetic recording medium.

2. Description of the Related Art

Accompanying the recent increase in recording density of magnetic recording media, higher coating smoothness has been desired. In order to obtain high coating smoothness, a technique of microparticulating a magnetic substance or highly dispersing a magnetic substance or a non-magnetic powder by applying strong shear to a coating liquid with a relatively high concentration such as a solids content concentration of 50 to 70 wt % has been used. Since the magnetic substance in particular is microparticulated and easily aggregates, in order to achieve sufficient dispersibility it is essential to carry out a dispersion treatment with strong shear.

On the other hand, accompanying smoothing of a coating, improvement of coating strength is also necessary. Because of this, a technique of improving durability by use of a radiation curing resin has been proposed (ref. JP-A-2002-342911, JP-A-62-214517, and JP-A-2005-158263 (JP-A denotes a Japanese unexamined patent application publication)).

For example, JP-A-2002-342911 discloses a magnetic recording medium comprising a non-magnetic support and, in order thereabove, a non-magnetic layer comprising a non-magnetic powder and a binder and at least one magnetic layer comprising a magnetic substance and a binder, wherein the magnetic substance is an acicular ferromagnetic substance having a major axis length of 20 to 100 nm or a tabular magnetic substance having a plate size of 10 to 50 nm, and at least the magnetic layer is obtained by applying a coating liquid that is obtained by kneading and/or dispersing the magnetic substance in, as a binder, a resin (A) having a hydroxy group or an amino group and having a molecular weight of 10,000 to 100,000, and subsequently adding thereto a compound (B) having an isocyanate group and a radiation curing functional group and having a molecular weight of 100 to 500.

Furthermore, JP-A-62-214517 discloses a magnetic recording medium wherein a magnetic layer is provided by curing by irradiation with radiation a coating formed above a substrate, the coating comprising as binder components for a magnetic powder an isocyanate compound having at least one isocyanate group and at least one carbon-carbon double bond and a binder resin containing a hydroxy group.

On the other hand, in order to enable high density recording for a coating type magnetic recording medium and improve electromagnetic conversion characteristics at short wavelength, measures have been taken such as improving magnetic characteristics by for example making a ferromagnetic powder finer, making a magnetic layer thinner, improving alignment, and improving packing properties, and improving surface properties in order to reduce spacing loss with respect to a head. JP-A-2005-158263 discloses a process for producing a coating type magnetic recording medium with a ferromagnetic powder-containing magnetic layer having a thickness of 0.05 to 1.0 μm for the purpose of providing a magnetic recording medium having good surface properties and excellent output in a short wavelength range without impairing durability and magnetic characteristics, the process comprising applying a middle layer to a support and drying it, and applying a ferromagnetic powder-containing magnetic coating material above the support having the middle layer at a shear rate of at least 150,000 sec⁻¹, the magnetic coating material having a wet coating thickness of no greater than 10.0 μm.

### BRIEF SUMMARY OF THE INVENTION

JP-A-2002-342911 and JP-A-62-214517 disclose the use of a binder having an isocyanate group and a radiation curing functional group in order to obtain excellent coating strength. However, such a magnetic recording medium cannot give sufficient sliding durability.

Furthermore, JP-A-2005-158263 proposes a sequential coating type magnetic recording medium in which a magnetic layer is provided above an electron beam-curing resin-containing middle layer that has been applied, dried, and then cured by irradiation with an electron beam, but when an electron beam-curing resin described in JP-A-2005-158263 is used, it is susceptible to thickening, and sufficient smoothness cannot be obtained.

It is an object of the present invention to provide a magnetic recording medium having excellent coating strength and electromagnetic conversion characteristics and having excellent transport durability.

The object of the present invention has been accomplished by means described in (1) below. This is described together with (2) to (17), which are preferred embodiments.

(1) A process for producing a magnetic recording medium, the process comprising in sequence a step of forming a non-magnetic layer by applying a non-magnetic coating liquid above a non-magnetic support, a step of curing the non-magnetic layer by irradiation with radiation, and a step of forming a magnetic layer above the cured non-magnetic layer, the non-magnetic coating liquid comprising a resin having a hydroxy group and/or an amino group and a compound having an isocyanato group and/or a substituent represented by Formula (1) below and a radiation curing functional group,

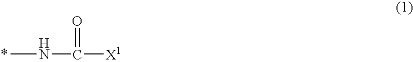

(in Formula (1) above, X¹ is Formula (2) or Formula (3) below, and * denotes a bonding position),

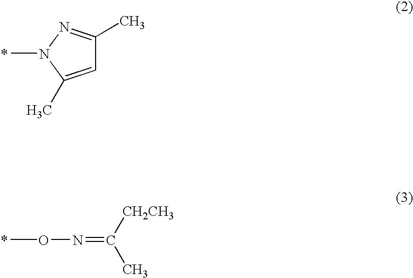

(2) the process for producing a magnetic recording medium according to (1) above, wherein the radiation curing functional group is an acryloyl group, a methacryloyl group, an acryloyloxy group, or a methacryloyloxy group,
(3) the process for producing a magnetic recording medium according to (1) or (2) above, wherein the compound having an isocyanato group and/or a substituent represented by Formula (1) above and a radiation curing functional group is represented by Formula (4) below,

R¹—X²—R² (4)

(in Formula (4) above, R¹ denotes an acryloyl group, a methacryloyl group, an acryloyloxy group, or a methacryloyloxy group, X² denotes a single bond, an alkylene group having 1 to 18 carbons, or a substituent represented by Formula (5) or Formula (6) below, and R² denotes an isocyanato group or a substituent represented by Formula (1) above)

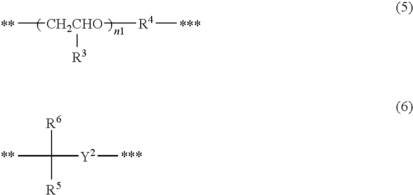

(in Formula (5) and Formula (6) above, R³ denotes a hydrogen atom or a methyl group, R⁴ denotes an alkylene group having 1 to 6 carbons, R⁵ and R⁶ independently denote an acryloyl group, a methacryloyl group, an acryloyloxy group, a methacryloyloxy group, a hydrogen atom, or a methyl group, Y² denotes a single bond or an alkylene group having 1 to 6 carbons, n1 is an integer of 1 to 20, ** denotes a position of bonding to R¹, and *** denotes a position of bonding to R²),
(4) the process for producing a magnetic recording medium according to any one of (1) to (3), wherein the non-magnetic powder has an average particle size of at least 5 nm but no greater than 2 μm,
(5) the process for producing a magnetic recording medium according to any one of (1) to (4), wherein the non-magnetic powder has a pH of at least 2 but no greater than 11,
(6) the process for producing a magnetic recording medium according to any one of (1) to (5), wherein the non-magnetic powder is titanium dioxide and/or α-iron oxide,
(7) the process for producing a magnetic recording medium according to any one of (1) to (6), wherein the non-magnetic layer comprises carbon black,
(8) the process for producing a magnetic recording medium according to any one of (1) to (7), wherein the resin having a hydroxy group and/or an amino group has a total hydroxy group and amino group content of 50 to 1,000 μeq/g,
(9) the process for producing a magnetic recording medium according to any one of (1) to (8), wherein the resin having a hydroxy group and/or an amino group has a molecular weight of 10,000 to 100,000,
(10) the process for producing a magnetic recording medium according to any one of (1) to (9), wherein the resin having a hydroxy group and/or an amino group comprises at least one type of polar group selected from the group consisting of —SO₃M, —SO₄M, —PO(OM)₂, —OPO(OM)₂, >NSO₃M, and >NRSO₃M (here, M is hydrogen or an alkali metal such as Na or K, and R is an alkylene group), and has a total content of said polar group of at least 10 μeq/g but no greater than 500 μg/eq,
(11) the process for producing a magnetic recording medium according to any one of (1) to (10), wherein the resin having a hydroxy group and/or an amino group is added in an amount of 5 to 30 wt % relative to the solids content of the non-magnetic coating liquid,
(12) the process for producing a magnetic recording medium according to any one of (1) to (11), wherein the compound having an isocyanato group and/or a substituent represented by Formula (1) above and a radiation curing functional group has a molecular weight of at least 90 but no greater than 10,000,
(13) the process for producing a magnetic recording medium according to any one of (1) to (12), wherein the non-magnetic coating liquid is prepared by a step of kneading and dispersing the resin having a hydroxy group and/or an amino group, the compound having an isocyanato group and/or a substituent represented by Formula (1) above and a radiation curing functional group, and a non-magnetic powder, or a step of adding to a non-magnetic powder the resin having a hydroxy group and/or an amino group and kneading, and then adding the compound having an isocyanato group and/or a substituent represented by Formula (1) above and a radiation curing functional group and dispersing,
(14) the process for producing a magnetic recording medium according to (13), wherein the solids content concentration in the kneading step is 70 to 90 wt %,
(15) the process for producing a magnetic recording medium according to (13) or (14), wherein the solids content concentration in the dispersing step is 20 to 50 wt %,
(16) the process for producing a magnetic recording medium according to any one of (13) to (15), wherein the temperature of the non-magnetic coating liquid in the kneading step and the dispersing step is 60° C. to 120° C., and
(17) the process for producing a magnetic recording medium according to any one of (1) to (16), wherein the step of curing the non-magnetic layer by irradiation with radiation is a step of irradiating with an electron beam and/or a step of irradiating with UV rays.

### DETAILED DESCRIPTION OF THE INVENTION

The process for producing a magnetic recording medium of the present invention comprises in sequence a step of forming a non-magnetic layer by applying a non-magnetic coating liquid above a non-magnetic support, a step of curing the non-magnetic layer by irradiation with radiation, and a step of forming a magnetic layer above the cured non-magnetic layer, the non-magnetic coating liquid comprising a resin having a hydroxy group and/or an amino group (hereinafter, also called resin (A)) and a compound having an isocyanato group and/or a substituent represented by Formula (1) above and a radiation curing functional group (hereinafter, also called compound (B)).

Accompanying the recent increase in recording density of magnetic recording media, higher coating smoothness has been desired. In order to obtain a magnetic recording medium having a smooth magnetic layer and excellent electromagnetic conversion characteristics, it is important for a non-magnetic layer, which is a layer beneath the magnetic layer, to have a smooth surface. Furthermore, when applying a magnetic layer above a non-magnetic layer, the magnetic layer is conventionally applied by a wet-on-wet coating method while the non-magnetic layer is in a wet state. Since in the wet-on-wet method the interface between the non-magnetic layer and the magnetic layer is disturbed and there is a problem with an increase in noise with respect to the electromagnetic conversion characteristics, a wet-on-dry method has been proposed.

In the wet-on-dry method, a non-magnetic coating liquid is first applied above one surface of a non-magnetic support and dried to thus form a non-magnetic layer, and the non-magnetic layer is then cured. Subsequently, a magnetic layer coating material is applied on top of the cured non-magnetic layer and dried to thus form a magnetic layer. Since a magnetic layer is provided on a smooth non-magnetic layer that is formed in advance, the interface between the non-magnetic layer and the magnetic layer is not disturbed, and a magnetic recording medium having excellent electromagnetic conversion characteristics is obtained. In order to cure the non-magnetic layer in such a wet-on-dry method, a method in which a radiation curing resin is used and radiation curing is carried out has been proposed.

JP-A-2005-158263 above proposes a magnetic recording medium formed by sequential coating in which a magnetic layer is provided on a starting material formed by applying and drying a non-magnetic layer comprising an electron beam-curing resin and then curing it by irradiation with an electron beam, but when the electron beam-curing resin is added to a non-magnetic powder during a kneading step in which a large amount of heat is generated due to strong shear, a radical polymerization reaction progresses due to the generation of heat, there is a large amount of thickening during kneading, and the powder used for the non-magnetic layer (non-magnetic powder) cannot be fully dispersed. A coating liquid for which the dispersibility is insufficient has high viscosity, the coating suitability of the non-magnetic layer is lost, and smoothness cannot be guaranteed.

In the present invention, a resin (resin (A)) having a hydroxy group and/or an amino group and a compound (compound (B)) having an isocyanato group and/or a substituent represented by Formula (1) above and a radiation curing functional group are added as a binder.

Furthermore, in JP-A-2002-342911, a resin (A) having a hydroxy group or an amino group and having a molecular weight of 10,000 to 200,000 and a compound (B) having a radiation curing functional group and having a molecular weight of 100 to 500 are used, but since a non-magnetic layer and a magnetic layer are applied by simultaneous multilayer coating, when an upper layer liquid is applied on top of a lower layer in a wet state, the interface between the upper layer and the lower layer is disturbed due to migration of non-adsorbed binder, etc. in the lower layer liquid into the upper layer liquid, sinking of the fine particulate magnetic substance into gaps between lower layer powder particles, etc., thus roughening the upper layer surface, and sufficient smoothness cannot be obtained.

In the present invention, before a magnetic layer is formed, a non-magnetic layer is irradiated with radiation. The present inventors have found that excellent magnetic layer smoothness, electromagnetic conversion characteristics, and transport durability can be obtained by forming a magnetic layer after a crosslinking reaction of resin (A) and compound (B) in the non-magnetic layer and a polymerization reaction of a radiation curing functional group have progressed sufficiently, and the present invention has thus been accomplished. Although the mechanism thereof has not been fully clarified, it is surmised that, when a magnetic coating liquid is applied, penetration of solvent and swelling are suppressed, and roughening of the magnetic layer surface is suppressed.

The process for producing a magnetic recording medium of the present invention is explained in detail below.

### Non-Magnetic Layer

A non-magnetic layer is formed by dispersing a non-magnetic powder in a binder. Furthermore, the non-magnetic layer may comprise as necessary carbon black or another component.

### Non-Magnetic Powder

The non-magnetic layer may employ a magnetic powder as long as the non-magnetic layer is substantially non-magnetic, but preferably employs a no n-magnetic powder.

The non-magnetic powder that can be used in the non-magnetic layer may be an inorganic substance or an organic substance. It is also possible to use carbon black, etc. Examples of the inorganic substance include a metal, a metal oxide, a metal carbonate, a metal sulfate, a metal nitride, a metal carbide, and a metal sulfide.

Specific examples thereof include a titanium oxide such as titanium dioxide, cerium oxide, tin oxide, tungsten oxide, ZnO, ZrO₂, SiO₂, Cr₂O₃, α-alumina having an α-component proportion of 90% to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, and they can be used singly or in a combination of two or more types. α-Iron oxide or a titanium oxide is preferable.

The form of the non-magnetic powder may be any one of acicular, spherical, polyhedral, and tabular.

The average particle size of these non-magnetic powders is preferably 5 nm to 2 μm, but it is possible to combine non-magnetic powders having different average particle sizes as necessary, or widen the particle size distribution of a single non-magnetic powder, thus producing the same effect. The average particle size of the non-magnetic powder is more preferably 10 to 200 nm and yet more preferably greater than 10 nm but no greater than 100 nm. It is preferable if it is in the range of 5 nm to 2 μm, since good dispersibility and a suitable surface roughness can be obtained.

The specific surface area of the non-magnetic powder is preferably 1 to 100 m²/g, more preferably 5 to 70 m²/g, and yet more preferably 10 to 65 m²/g. It is preferable if the specific surface area is in the range of 1 to 100 m²/g, since a suitable surface roughness can be obtained, and dispersion can be carried out using a desired amount of binder.

The DBP oil absorption is preferably 5 to 100 mL/100 g, more preferably 10 to 80 mL/100 g, and yet more preferably 20 to 60 mL/100 g.

The specific gravity is preferably 1 to 12, and more preferably 3 to 6. The tap density is preferably 0.05 to 2 g/mL, and more preferably 0.2 to 1.5 g/mL. When the tap density is in the range of 0.05 to 2 g/mL, there is little scattering of particles, the operation is easy, and there tends to be little sticking to equipment.

The pH of the non-magnetic powder is preferably 2 to 11, and particularly preferably 6 to 9. When the pH is in the range of 2 to 11, the coefficient of friction does not increase as a result of high temperature and high humidity or release of a fatty acid.

The water content of the non-magnetic powder is preferably 0.1 to 5 wt %, more preferably 0.2 to 3 wt %, and yet more preferably 0.3 to 1.5 wt %. It is preferable if the water content is in the range of 0.1 to 5 wt %, since dispersion is good, and the viscosity of a dispersed coating solution becomes stable.

The ignition loss is preferably 20 wt % or less, and a small ignition loss is preferable.

When the non-magnetic powder is an inorganic powder, the Mohs hardness thereof is preferably in the range of 4 to 10. When the Mohs hardness is in the range of 4 to 10, it is possible to guarantee the durability. The amount of stearic acid absorbed by the non-magnetic powder is preferably 1 to 20 μmol/m², and more preferably 2 to 15 μmol/m².

The heat of wetting of the non-magnetic powder in water at 25° C. is preferably in the range of 20 to 60 μJ/cm² (200 to 600 erg/cm²). It is possible to use a solvent that gives a heat of wetting in this range.

The number of water molecules on the surface at 100° C. to 400° C. is suitably 1 to 10/100 Å. The pH at the isoelectric point in water is preferably between 3 and 9.

The surface of the non-magnetic powder is preferably subjected to a surface treatment with Al₂O₃, SiO₂, TiO₂, ZrO₂, SnO₂, Sb₂O₃, or ZnO. In terms of dispersibility in particular, Al₂O₃, SiO₂, TiO₂, and ZrO₂ are preferable, and Al₂O₃, SiO₂, and ZrO₂ are more preferable. They may be used in combination or singly. Depending on the intended purpose, a surface-treated layer may be obtained by co-precipitation, or a method can be employed in which the surface is firstly treated with alumina and the surface thereof is then treated with silica, or vice versa. The surface-treated layer may be formed as a porous layer depending on the intended purpose, but it is generally preferable for it to be uniform and dense.

Specific examples of the non-magnetic powder used in the non-magnetic layer of the present invention include Nanotite (manufactured by Showa Denko K.K.), HIT-100 and ZA-G1 (manufactured by Sumitomo Chemical Co., Ltd.), DPN-250, DPN-250BX, DPN-245, DPN-270BX, DPB-550BX, and DPN-550RX (manufactured by Toda Kogyo Corp.), titanium oxide TTO-51B, TTO-55A, TTO-55B, TTO-55C, TTO-55S, TTO-55D, and SN-100, MJ-7, α-iron oxide E270, E271, and E300 (manufactured by Ishihara Sangyo Kaisha Ltd.), titanium oxide STT-4D, STT-30D, STT-30, and STT-65C (manufactured by Titan Kogyo Kabushiki Kaisha), MT-100S, MT-100T, MT-150W, MT-500B, MT-600B, MT-100F, and MT-500HD (manufactured by Tayca Corporation), FINEX-25, BF-1, BF-10, BF-20, and ST-M (manufactured by Sakai Chemical Industry Co., Ltd.), DEFIC-Y and DEFIC-R (manufactured by Dowa Mining Co., Ltd.), AS2BM and TiO2P25 (manufactured by Nippon Aerosil Co., Ltd.), 100A, and 500A (manufactured by Ube Industries, Ltd.), Y-LOP (manufactured by Titan Kogyo Kabushiki Kaisha), and calcined products thereof. Particularly preferred non-magnetic powders are titanium dioxide and α-iron oxide.

### Carbon Black

In the non-magnetic layer, it is preferable to mix carbon black together with the non-magnetic powder. By mixing carbon black with the non-magnetic powder, the surface electrical resistance of the non-magnetic layer can be reduced, the light transmittance can be decreased, and a desired μVickers hardness can be obtained. The μVickers hardness of the non-magnetic layer is usually 25 to 60 kg/mm², and is preferably 30 to 50 kg/mm² in order to adjust the head contact, and can be measured using a thin film hardness meter (HMA-400 manufactured by NEC Corporation) with, as an indentor tip, a triangular pyramidal diamond needle having a tip angle of 80° and a tip radius of 0.1 μm. The light transmittance is generally standardized such that the absorption of infrared rays having a wavelength of on the order of 900 nm is 3% or less and, in the case of, for example, VHS magnetic tapes, 0.8% or less. Because of this, furnace black for rubber, thermal black for rubber, carbon black for coloring, acetylene black, etc. can be used.

The specific surface area of the carbon black used in the non-magnetic layer of the present invention is preferably 100 to 500 m²/g, and more preferably 150 to 400 m²/g, and the DBP oil absorption thereof is preferably 20 to 400 mL/100 g, and more preferably 30 to 200 mL/100 g. The particle size of the carbon black is preferably 5 to 80 nm, more preferably 10 to 50 nm, and yet more preferably 10 to 40 nm. The pH of the carbon black is preferably 2 to 10, the water content thereof is preferably 0.1% to 10%, and the tap density is preferably 0.1 to 1 g/mL.

Specific examples of the carbon black that can be used in the non-magnetic layer of the present invention include BLACKPEARLS 2000, 1300, 1000, 900, 800, 880 and 700, and VULCAN XC-72 (manufactured by Cabot Corporation), #3050B, #3150B, #3250B, #3750B, #3950B, #950, #650B, #970B, #850B, and MA-600 (manufactured by Mitsubishi Chemical Corporation), CONDUCTEX SC, RAVEN 8800, 8000, 7000, 5750, 5250, 3500, 2100, 2000, 1800, 1500, 1255 and 1250 (manufactured by Columbian Carbon Co.), and Ketjen Black EC (manufactured by Akzo).

The carbon black may be surface treated using a dispersant or grafted with a resin, or part of the surface thereof may be converted into graphite. Prior to adding carbon black to a coating solution, the carbon black may be predispersed with a binder. The carbon black is preferably used in a range that does not exceed 50 wt % of the above-mentioned inorganic powder and in a range that does not exceed 40 wt % of the total weight of the non-magnetic layer. These types of carbon black may be used singly or in combination. The carbon black that can be used in the non-magnetic layer of the present invention can be selected by referring to, for example, the ‘Kabon Burakku Handobukku’ (Carbon Black Handbook) (edited by the Carbon Black Association of Japan).

It is also possible to add an organic powder to the non-magnetic layer, depending on the intended purpose. Examples of such an organic powder include an acrylic styrene resin powder, a benzoguanamine resin powder, a melamine resin powder, and a phthalocyanine pigment, but a polyolefin resin powder, a polyester resin powder, a polyamide resin powder, a polyimide resin powder, and a polyfluoroethylene resin can also be used. Production methods such as those described in JP-A-62-18564 and JP-A-60-255827 can be used.

### Binder

In the present invention, the binder contained in the non-magnetic layer comprises a resin (resin (A)) having a hydroxy group and/or an amino group. Furthermore, it comprises in addition thereto a compound (compound (B)) having an isocyanato group and/or a substituent represented by Formula (1) above and a radiation curing functional group.

In the present invention, by forming a non-magnetic layer by using a non-magnetic coating liquid comprising resin (A) and compound (B), a non-magnetic layer having excellent coating strength and smoothness and good dispersibility for a non-magnetic powder can be obtained, and this enables a magnetic recording medium having excellent smoothness, electromagnetic conversion characteristics, and transport durability to be provided.

### Resin (A)

Resin (A) contains a hydroxy group and/or an amino group, and preferably contains a hydroxy group or an amino group. That is, resin (A) is preferably a resin having either one of a hydroxy group and an amino group.

As the skeleton of resin (A), a single resin or a mixture of a plurality of resins from a polyurethane resin, a polyester resin, a polyamide resin, a vinyl chloride resin, an acrylic resin in which styrene, acrylonitrile, methyl methacrylate, etc. are copolymerized, a cellulose resin such as nitrocellulose, an epoxy resin, a phenoxy resin, a polyvinyl alkylal resin such as polyvinyl acetal or polyvinyl butyral, etc. may be used.

Resin (A) contains a hydroxy group (OH group) and/or an amino group. The coating strength can be enhanced as a result of bonding and crosslinking between the hydroxy group (OH group) and/or amino group of resin (A) and an isocyanato group of compound (B), which is described later. The total content of the hydroxy group (OH) group and amino group of resin (A) is preferably 50 to 1,000 μeq/g, and yet more preferably 100 to 500 μeq/g. It is preferable for the content of the hydroxy group (OH group) and amino group to be at least 50 μeq/g since the coating strength can be improved, and for it to be no greater than 1,000 μeq/g since the dispersibility is good.

The molecular weight of resin (A) is preferably 10,000 to 200,000, and more preferably 20,000 to 100,000. It is preferable for the molecular weight to be in the above-mentioned range since good coating strength can be obtained, the solvent solubility is excellent, and the dispersibility of a non-magnetic powder is high.

Resin (A) may contain a polar group in addition to a hydroxy group (OH group) and an amino group. The presence of a polar group enables the adsorbability of resin (A) onto the surface of a non-magnetic powder to be enhanced, and the dispersibility of the non-magnetic powder to be further improved. Examples of the polar group that resin (A) may contain include —SO₃M, —SO₄M, —PO(OM)₂, —OPO(OM)₂, >NSO₃M, and >NRSO₃M (M is hydrogen or an alkali metal such as Na or K and R is an alkylene group). Among them, —SO₃M and —SO₄M are preferable. The polar group content is preferably 10 to 500 μeq/g. It is preferable for the polar group content to be at least 10 μeq/g since the adsorbability of resin (A) onto a non-magnetic powder becomes high and the dispersibility is good, and for it to be no greater than 500 μeq/g since the solvent solubility is high and the dispersibility is good.

The amount of resin (A) added is preferably 5 to 30 wt % relative to the solids content (the total weight excluding the solvent) of the non-magnetic coating liquid, more preferably 5 to 25 wt %, and yet more preferably 5 to 20 wt %.

It is preferable for the amount of resin (A) added to be at least 5 wt % since the dispersibility can be guaranteed, and for it to be no greater than 30 wt % since the moldability by a calendar treatment is good, and sufficient smoothness and packing properties of the magnetic substance in the magnetic layer can be guaranteed.

### Compound (B)

In the present invention, the non-magnetic layer comprises, together with resin (A) above, a compound (compound (B)) having an isocyanato group (the isocyanato group (—N═C═O) is also called an isocyanate group) and/or a substituent represented by Formula (1) below and a radiation curing functional group.

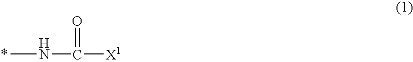

(In Formula (1) above, X¹ is Formula (2) or Formula (3) below, and * denotes a bonding position.)

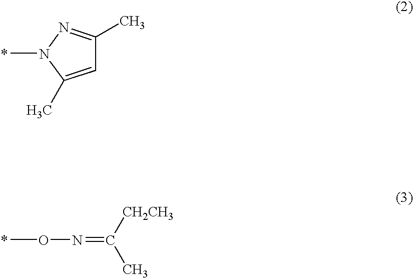

The substituent represented by Formula (2) or Formula (3) above is a substituent that protects (blocks) an isocyanato group and turns into an isocyanato group as a result of deprotection by heating, etc.

The coating strength and the durability can be enhanced by bonding of the isocyanato group contained in compound (B) or the isocyanato group that is formed by deprotection of the substituent represented by Formula (2) or Formula (3) above (hereinafter, the ‘substituent represented by Formula (2) or Formula (3)’ is also called a ‘blocked isocyanato group’) to the hydroxy group or the amino group contained in resin (A), or by crosslinking of the radiation curing functional group contained in compound (B).

The radiation curing functional group is preferably a group having an ethylenically unsaturated bond, that is, compound (B) is preferably an ethylenically unsaturated compound having an isocyanato group and/or a blocked isocyanato group.

Examples of the group having an ethylenically unsaturated bond include an acryloyl group, a methacryloyl group, an acryloyloxy group, a methacryloyloxy group, an acrylamide group, a methacrylamide group, and a vinyl group; in the present invention an acryloyl group, a methacryloyl group, an acryloyloxy group, or a methacryloyloxy group is preferable, and an acryloyloxy group or a methacryloyloxy group is more preferable.

Examples of compound (B) include isocyanatoethyl (meth)acrylate, isocyanatopropyl (meth)acrylate, isocyanatobutyl (meth)acrylate, isocyanatopentyl (meth)acrylate, isocyanatohexyl (meth)acrylate, isocyanatoheptyl (meth)acrylate, isocyanatooctyl (meth)acrylate, isocyanatononyl (meth)acrylate, isocyanatodecyl (meth)acrylate, isocyanatoundecyl (meth)acrylate, isocyanatododecyl (meth)acrylate, isocyanatotridecyl (meth)acrylate, isocyanatomyristyl (meth)acrylate, isocyanatopentadecyl (meth)acrylate, isocyanatopalmityl (meth)acrylate, isocyanatoheptadecyl (meth)acrylate, isocyanatostearyl (meth)acrylate, 2-(meth)acryloyloxyethoxyethyl isocyanate, 2-(meth)acryloyloxypropoxyethyl isocyanate, compounds formed by adding ethylene oxide or propylene oxide to the above compounds, 1,1-bis((meth)acryloyloxymethyl)ethyl isocyanate, 2-(meth)acryloyloxymethyl-2-propyl isocyanate, 1,3-di(meth)acryloyloxy-2-(meth)acryloyloxymethyl-2-propyl isocyanate, and (meth)acryloyl isocyanate. Examples further include a monomer formed by blocking an isocyanato group with 3,5-dimethylpyrazole (e.g. Karenz MOI-BP (Showa Denko K.K.)) and a monomer formed by blocking an isocyanato group by methyl ethyl ketone oxime (e.g. Karenz MOI-BM). Furthermore, a compound formed by adding 1 mole of a hydroxy(meth)acrylate to 1 mole of a diisocyanate compound may also be used.

Some compounds (B) are commercially available, and examples thereof include the Karenz series such as Karenz MOI (2-methacryloyloxyethyl acrylate), Karenz AOI (2-acryloyloxyethyl acrylate), Karenz MOI-EG (2-methacryloyloxyethoxyethyl isocyanate), Karenz MOI-BM (2-s0-(1′-methylpropylideneamino)carboxyamino]ethyl methacrylate), Karenz MOI-BP (2-[(3′,5′-dimethylpyrazolyl)carboxyamino]ethyl methacrylate), and Karenz BEI (1,1-bis(acryloyloxymethyl)ethyl isocyanate) (all manufactured by Showa Denko K.K.), and MAI (methacryloyl isocyanate, manufactured by Nippon Paint Co., Ltd.).

Preferred ones are isocyanatoethyl (meth)acrylate, isocyanatopropyl (meth)acrylate, isocyanatobutyl (meth)acrylate, the Karenz series manufactured by Showa Denko K.K., MAI manufactured by Nippon Paint Co., Ltd., and acryloyl isocyanate.

The compound formed by adding 1 mol of hydroxy (meth)acrylate to 1 mol of a diisocyanate compound has a urethane bond in the molecule, the solvent solubility thereof therefore tends to become low, and the dispersibility of a non-magnetic powder might be degraded.

The molecular weight of compound (B) is preferably 90 to 10,000, and more preferably 90 to 5,000. It is preferable for the molecular weight to be at least 90 since release during a drying step after applying the non-magnetic coating liquid can be suppressed. It is also preferable for the molecular weight to be no greater than 10,000 since thinning of a coating does not occur and tackiness does not occur during calendering.

Compound (B) is preferably a compound represented by, for example, Formula (4) below.

R¹—X²—R² (4)

In Formula (4) above, R¹ denotes an acryloyl group, a methacryloyl group, an acryloyloxy group, or a methacryloyloxy group, X² denotes a single bond, an alkylene group having 1 to 18 carbons, or a substituent represented by Formula (5) or Formula (6) below, and R² denotes an isocyanato group or a substituent represented by Formula (1) above.

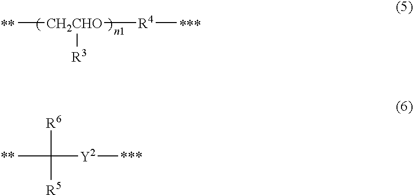

In Formula (5) and Formula (6) above, R³ denotes a hydrogen atom or a methyl group, R⁴ denotes an alkylene group having 1 to 6 carbons, R⁵ and R⁶ independently denote an acryloyl group, a methacryloyl group, an acryloyloxy group, a methacryloyloxy group, a hydrogen atom, or a methyl group, Y² denotes a single bond or an alkylene group having 1 to 6 carbons, and n1 is an integer of 1 to 20. ** denotes a position of bonding to R¹, and *** denotes a position of bonding to R².

In Formula (5) and Formula (6) above, R³ is preferably a hydrogen atom, and R⁴ is preferably an alkylene group having 2 to 4 carbons and more preferably an alkylene group having 2 or 3 carbons (an ethylene group or a propylene group).

R⁵ and R⁶ are preferably an acryloyl group or a methacryloyl group.

Y is preferably a single bond or an alkylene group having 1 to 4 carbons, and more preferably a single bond or an alkylene group having 1 to 3 carbons. n1 is preferably 1 to 16, more preferably 1 to 8, and yet more preferably 1 to 4.

The amount of compound (B) added is preferably adjusted so that the equivalents of the hydroxy group and amino group of resin (A) to the (blocked) isocyanato group of compound (B) is (hydroxy group and amino group): (isocyanato group)=1:0.80 to 1:1.20, more preferably 1:0.90 to 1:1.10, and yet more preferably 1:0.95 to 1:1.05.

It is preferable for the amount of compound (B) added to be in the above-mentioned range since the crosslink density can be guaranteed and residual unreacted compound (B) component does not leach into the magnetic layer.

In the present invention, the non-magnetic layer may use, in combination with the above-mentioned crosslinking agent (compound (B)), a di- or higher-functional compound having radiation curing functional groups. The di- or higher-functional compound having radiation curing functional groups is preferably added so that the solids content concentration in the coating liquid is 5 to 30 wt %.

As the di- or higher-functional compound having radiation curing functional groups, an acrylic acid ester, an acrylamide, a methacrylic acid ester, a methacrylamide, an allyl compound, a vinyl ether, a vinyl ester, etc. can be cited.

Specific examples of the difunctional compound that can be used include those in which acrylic acid or methacrylic acid is added to an aliphatic diol, represented by ethylene glycol diacrylate, propylene glycol diacrylate, butanediol diacrylate, hexanediol diacrylate, diethylene glycol diacrylate, triethylene glycol diacrylate, tetraethylene glycol diacrylate, neopentyl glycol diacrylate, tripropylene glycol diacrylate, ethylene glycol dimethacrylate, propylene glycol dimethacrylate, butanediol dimethacrylate, hexanediol dimethacrylate, diethylene glycol dimethacrylate, triethylene glycol dimethacrylate, tetraethylene glycol dimethacrylate, neopentyl glycol dimethacrylate, tripropylene glycol dimethacrylate, etc. Furthermore, a polyether acrylate and a polyether methacrylate in which acrylic acid or methacrylic acid is added to a polyether polyol such as polyethylene glycol, polypropylene glycol, or polytetramethylene glycol, and a polyester acrylate and a polyester methacrylate in which acrylic acid or methacrylic acid is added to a polyester polyol obtained from a known dibasic acid and glycol may also be used. A polyurethane acrylate and a polyurethane methacrylate in which acrylic acid or methacrylic acid is added to a polyurethane obtained by reaction of a known polyol or diol and a polyisocyanate may be used. It is also possible to use one in which acrylic acid or methacrylic acid is added to bisphenol A, bisphenol F, hydrogenated bisphenol A, hydrogenated bisphenol F, or an alkylene oxide adduct thereof, or one having a ring structure such as an alkylene oxide isocyanurate-modified diacrylate, an alkylene oxide isocyanurate-modified dimethacrylate, tricyclodecanedimethanol diacrylate, or tricyclodecanedimethanol dimethacrylate.

Specific examples of a trifunctional compound that can be used include trimethylolpropane triacrylate, trimethylolethane triacrylate, an alkylene oxide-modified trimethylolpropane triacrylate, pentaerythritol triacrylate, dipentaerythritol triacrylate, an alkylene oxide-modified isocyanurate triacrylate, dipentaerythritol propionate triacrylate, hydroxypivalaldehyde-modified dimethylolpropane triacrylate, trimethylolpropane trimethacrylate, an alkylene oxide-modified trimethylolpropane trimethacrylate, pentaerythritol trimethacrylate, dipentaerythritol trimethacrylate, an alkylene oxide-modified isocyanurate trimethacrylate, dipentaerythritol propionate trimethacrylate, and hydroxypivalaldehyde-modified dimethylolpropane trimethacrylate.

Specific examples of a tetra- or higher-functional compound that can be used include pentaerythritol tetraacrylate, ditrimethylolpropane tetraacrylate, dipentaerythritol pentaacrylate, dipentaerythritol propionate tetraacrylate, dipentaerythritol hexaacrylate, and an alkylene oxide-modified phosphazene hexaacrylate.

Among them, specific preferred examples include a tri- or higher-functional acrylate compound having a molecular weight of 200 to 2,000. More preferred examples include trimethylolpropane triacrylate, pentaerythritol tetraacrylate, dipentaerythritol pentaacrylate, and dipentaerythritol hexaacrylate. These compounds may be used as a mixture at any ratio and may be used in combination with a known acrylate or methacrylate compound described in ‘Teienerugi Denshisen Shosha no Oyogijutsu’ (Low Energy Electron Beam) (CMC, 2000), ‘UV•EB Koka Gijutsu’ (UV•EB Curing Technology) (Sogo Gijutsu Center, 1982), etc.

In the present invention, it is preferable to use resin (A) and compound (B), but the present invention is not limited thereto as long as the viscosity is sufficiently low during application and sufficient coating strength can be obtained after curing by a crosslinking reaction of a radiation curing functional group, etc.

For example, there is (1) a method in which a radiation curing functional group is introduced into a resin in two steps by introducing an isocyanato group into a resin by using in combination a resin having a hydroxy group and/or an amino group and a diisocyanate compound (compound having two isocyanato groups), and by using the resin and a compound having a hydroxy group and/or an amino group and a radiation curing functional group, and (2) a resin having an isocyanato group and a compound having a hydroxy group and/or an amino group and a radiation curing functional group can also be used.

### Binder Used in Combination

Examples of a binder used in combination with resin (A) include a polyurethane resin having no hydroxy group and amino group, a polyester resin, a polyamide resin, a vinyl chloride resin, an acrylic resin obtained by copolymerization of styrene, acrylonitrile, methyl methacrylate, etc., a cellulose resin such as nitrocellulose, an epoxy resin, a phenoxy resin, and a polyvinyl alkylal resin such as polyvinyl acetal or polyvinyl butyral, and they can be used singly or in a combination of two or more types. Among these, the polyurethane resin and the acrylic resin are preferable.

In order to improve the dispersibility of the non-magnetic powder, the binder preferably has a functional group (polar group) that is adsorbed on the surface of the powders. Preferred examples of the functional group include —SO₃M, —SO₄M, —PO(OM)₂, —OPO(OM)₂, —COOM, >NSO₃M, >NRSO₃M, —NR¹R², and —N⁺R¹R²R³X⁻. M denotes a hydrogen atom or an alkali metal such as Na or K, R denotes an alkylene group, R¹, R², and R³ denote alkyl groups, hydroxyalkyl groups, or hydrogen atoms, and X denotes a halogen such as Cl or Br. The amount of functional group in the binder is preferably 10 to 500 μeq/g, and more preferably 30 to 120 μeq/g. It is preferable if the amount of functional group in the binder is in this range since good dispersibility can be achieved. In addition, the binder has a functional group such as hydroxy group which comprises an active hydrogen. The weight-average molecular weight of the binder used in combination is preferably 20,000 to 200,000 and more preferably 20,000 to 150,000. When the weight-average molecular weight is in such a range, good coating strength and good durability can be obtained. Furthermore, since the viscosity is low, good durability can be obtained.

In the present invention, the above-mentioned binder (resin (A), compound (B) and the binder used in combination) can be used not only in the non-magnetic layer but also in the upper magnetic layer. The amount of the binder added is preferably 50 to 800 parts by weight and more preferably 100 to 400 parts by weight relative to 1,000 parts by weight of the non-magnetic powder in case of the non-magnetic layer and relative to 1,000 parts by weight of the magnetic powder in case of the magnetic layer.

The above-mentioned components are kneaded with and dispersed in a solvent such as methyl ethyl ketone, dioxane, cyclohexanone, or ethyl acetate, which are usually used when preparing a magnetic coating material, thus giving a non-magnetic coating liquid. Kneading and dispersion may be carried out in accordance with a standard method. A preferred method for preparing a non-magnetic coating liquid is explained later.

### Other Component

The non-magnetic coating liquid may contain, in addition to the above-mentioned components, a usually used additive or a filler, for example, an abrasive such as α-Al₂O₃ or Cr₂O₃, an antistatic agent such as carbon black, a lubricant such as a fatty acid, a fatty acid ester, or a silicone oil, or a dispersing agent.

In the present invention, a known additive may be added to both the non-magnetic layer and the magnetic layer. As the additive, one having a lubrication effect, an antistatic effect, a dispersion effect, a plasticizing effect, etc. may be used. Molybdenum disulfide, tungsten disulfide, graphite, boron nitride, graphite fluoride, silicone oil, a polar group-containing silicone, a fatty acid-modified silicone, a fluorine-containing silicone, a fluorine-containing alcohol, a fluorine-containing ester, a polyolefin, a polyglycol, an ester of an alkylphosphoric acid and an alkali metal salt thereof, an ester of an alkylsulfuric acid and an alkali metal salt thereof, a polyphenyl ether, an ester of a fluorine-containing alkylsulfuric acid and an alkali metal salt thereof, a monobasic fatty acid having 10 to 24 carbons (may contain an unsaturated bond and may be branched) and a metal salt thereof (Li, Na, K, Cu, etc.), a monohydric, dihydric, trihydric, tetrahydric, pentahydric, or hexahydric alcohol having 12 to 22 carbons (may contain an unsaturated bond and may be branched), an alkoxy alcohol having 12 to 22 carbons, a monofatty acid ester, difatty acid ester, or trifatty acid ester formed from a monobasic fatty acid having 10 to 24 carbons (may contain an unsaturated bond and may be branched) and any one of monohydric, dihydric, trihydric, tetrahydric, pentahydric, and hexahydric alcohols having 2 to 12 carbons (may contain an unsaturated bond and may be branched), a fatty acid ester of a monoalkyl ether of an alkylene oxide polymer, a fatty acid amide having 8 to 22 carbons, an aliphatic amine having 8 to 22 carbons, etc. may be used.

Specific examples thereof include lauric acid, myristic acid, palmitic acid, stearic acid, behenic acid, butyl stearate, oleic acid, linoleic acid, linolenic acid, elaidic acid, octyl stearate, amyl stearate, isooctyl stearate, octyl myristate, butoxyethyl stearate, anhydrosorbitan monostearate, anhydrosorbitan distearate, anhydrosorbitan tristearate, oleyl alcohol, and lauryl alcohol. Furthermore, a nonionic surfactant such as an alkylene oxide-based surfactant, a glycerol-based surfactant, a glycidol-based surfactant, or an alkylphenol ethylene oxide adduct, a cationic surfactant such as a cyclic amine, an ester amide, a quaternary ammonium salt, a hydantoin derivative, a heterocycle, a phosphonium, or a sulfonium, an anionic surfactant containing an acidic group such as a carboxylic acid, a sulfonic acid, a phosphoric acid, a sulfate ester group, or a phosphate ester group, or an amphoteric surfactant such as an amino acid, an aminosulfonic acid, a sulfuric acid or phosphoric acid ester of an amino alcohol, or an alkylbetaine type surfactant may be used.

These surfactants are described in detail in ‘Kaimenkasseizai Binran’ (Surfactant Handbook) (published by Sangyo Tosho Publishing). These lubricants, antistatic agents, etc. need not be 100% pure, and may contain, in addition to the main component, an impurity such as an isomer, an unreacted material, a by-product, a decomposition product, or an oxide. The content of such an impurity is preferably no greater than 30%, and yet more preferably no greater than 10%.

The type and the amount of the lubricant and surfactant used in the present invention may be changed as necessary in the magnetic layer (upper layer) and the non-magnetic layer (lower layer). For example, their exudation to the surface is controlled by using fatty acids having different melting points for the magnetic layer (upper layer) and the non-magnetic layer (lower layer) or by using esters having different boiling points or polarity; the coating stability can be improved by regulating the amount of surfactant, and the lubrication effect can be improved by increasing the amount of lubricant added to the non-magnetic layer (lower layer), but the present invention should not be construed as being limited only to the examples illustrated here. All or a part of the additives used in the present invention may be added to a non-magnetic coating liquid at any stage of its preparation. For example, the additives may be blended with a non-magnetic powder prior to a kneading step, they may be added in a step of kneading a non-magnetic powder, a binder, and a solvent, they may be added in a dispersing step, they may be added after dispersion, or they may be added immediately prior to coating.

Product examples of the lubricants used in the present invention include NAA-102, NAA-415, NAA-312, NAA-160, NAA-180, NAA-174, NAA-175, NAA-222, NAA-34, NAA-35, NAA-171, NAA-122, NAA-142, NAA-160, NAA-173K, hardened castor oil fatty acid, NAA-42, NAA-44, Cation SA, Cation MA, Cation AB, Cation BB, Nymeen L-201, Nymeen L-202, Nymeen S-202, Nonion E-208, Nonion P-208, Nonion S-207, Nonion K-204, Nonion NS-202, Nonion NS-210, Nonion HS-206, Nonion L-2, Nonion S-2, Nonion S-4, Nonion 0-2, Nonion LP-20R, Nonion PP-40R, Nonion SP-60R, Nonion OP-80R, Nonion OP-85R, Nonion LT-221, Nonion ST-221, Nonion OT-221, Monogly MB, Nonion DS-60, Anon BF, Anon LG, butyl stearate, butyl laurate, and erucic acid, manufactured by NOF Corporation; oleic acid, manufactured by Kanto Kagaku; FAL-205 and FAL-123, manufactured by Takemoto Oil & Fat Co., Ltd.; NJLUB LO, NJLUB IPM, and Sansocizer E4030, manufactured by New Japan Chemical Co., Ltd.; TA-3, KF-96, KF-96L, KF96H, KF410, KF420, KF965, KF54, KF50, KF56, KF907, KF851, X-22-819, X-22-822, KF905, KF700, KF393, KF-857, KF-860, KF-865, X-22-980, KF-101, KF-102, KF-103, X-22-3710, X-22-3715, KF-910, and KF-3935, manufactured by Shin-Etsu Chemical Co., Ltd.; Amide P, Amide C, and Armoslip CP, manufactured by Lion Akzo Co., Ltd.; Duomin TDO, manufactured by Lion Corporation; BA-41G, manufactured by The Nisshin Oil Mills, Ltd.; and Profan 2012E, Newpol PE61, Ionet MS-400, Ionet MO-200, Ionet DL-200, Ionet DS-300, Ionet DS-1000, and Ionet DO-200, manufactured by Sanyo Chemical Industries, Ltd.

As organic solvents used in the present invention, ketones such as acetone, methyl ethyl ketone, methyl isobutyl ketone, diisobutyl ketone, cyclohexanone, and isophorone, alcohols such as methanol, ethanol, propanol, butanol, isobutyl alcohol, isopropyl alcohol, and methylcyclohexanol, esters such as methyl acetate, butyl acetate, isobutyl acetate, isopropyl acetate, ethyl lactate, and glycol acetate, glycol ethers such as glycol dimethyl ether, glycol monoethyl ether, and dioxane, aromatic hydrocarbons such as benzene, toluene, xylene, cresol, and chlorobenzene, chlorohydrocarbons such as methylene chloride, ethylene chloride, carbon tetrachloride, chloroform, ethylene chlorohydrin, and dichlorobenzene, N,N-dimethylformamide, hexane, tetrahydrofuran, etc. may be used at any ratio. These organic solvents need not be always 100% pure, and may contain, in addition to the main component, an impurity such as an isomer, an unreacted material, a by-product, a decomposition product, an oxide, or moisture. The content of such an impurity is preferably no greater than 30%, and yet more preferably no greater than 10%. The type of organic solvent used in the present invention is preferably the same for the magnetic layer (upper layer) and the non-magnetic layer (lower layer). The amount added may be varied. The coating stability is improved by using a solvent having a high surface tension (cyclohexanone, dioxane, etc.) in the non-magnetic layer (lower layer); specifically, it is essential that the arithmetic mean value of a solvent composition for the magnetic layer (upper layer) is not smaller than the arithmetic mean value of a solvent composition for the non-magnetic layer (lower layer). In order to improve the dispersibility, it is preferable for the polarity to be somewhat strong, and the solvent composition preferably contains 50% or more of a solvent having a permittivity of 15 or higher. The solubility parameter is preferably 8 to 11.

### Preparation of Non-Magnetic Coating Liquid

In the present invention, a method for preparing the non-magnetic coating liquid is not particularly limited, and as described above a known preparation method may be appropriately selected and used.

Among them, the non-magnetic coating liquid is preferably one prepared by a step of adding resin (A) and compound (B) to a non-magnetic powder and kneading and dispersing the non-magnetic powder, or a step of adding resin (A) to a non-magnetic powder and kneading, and then adding compound (B) thereto and dispersing it.

In the present invention, ‘kneading’ is a step carried out using a kneading machine such as an open kneader, a continuous kneader, a pressure kneader, or a roll mill in which a non-magnetic powder, a binder, a solvent, as necessary an abrasive, etc. are at a higher solids content concentration than in the dispersing step below. In the present invention, ‘dispersing’ is a step in which a kneaded material obtained in the above-mentioned kneading treatment or a non-magnetic powder, together with a binder, a solvent, as necessary an abrasive, etc. are dispersed using glass beads, steel beads, or ceramic beads, which have an average particle size of 0.1 to 1.5 mm. As a dispersing machine, a sand mill, a ball mill, a pebble mill, a Tron mill, a high speed impeller mill, a high speed stone mill, a high speed impact mill, etc. may be used. The dispersion step is carried out in a system in which the solids content concentration is low compared with the kneading step. Furthermore, in the present invention, ‘adding’ is a step in which a compound, etc. is added to a coating liquid, and is a step in which a compound added to a coating liquid is uniformly mixed simply by stirring using a disper, etc. without applying strong shear as in the above-mentioned kneading or dispersion step.

Heat generated by kneading or dispersion promotes a reaction of an isocyanato group of compound (B) and a hydroxy group or an amino group of binder (A). There is a possibility that some of the radiation curing functional groups (preferably, the ethylenically unsaturated bonds) of compound (B) might undergo a radical polymerization reaction, but it has been found that, since compound (B) has a low molecular weight, thickening and a dispersion degradation effect, which are caused when a radiation-curing resin is added in advance during kneading or dispersion, can be avoided. Furthermore, it has been found that the dispersibility of the non-magnetic powder is excellent, and excellent coating strength can be obtained.

That is, a preferred embodiment of the present invention is as follows.

(1) A method for preparing a non-magnetic coating liquid by adding resin (A) and compound (B) to a non-magnetic powder at 5 to 40 wt % and 1 to 30 wt % respectively relative to the non-magnetic powder, and more preferably 10 to 30 wt % and 1 to 20 wt %, kneading, and dispersing, or
(2) a method for preparing a non-magnetic coating liquid by adding resin (A) to a non-magnetic powder at 5 to 40 wt % relative to the non-magnetic powder, and more preferably 10 to 30 wt %, kneading, and then adding compound (B) at 1 to 30 wt % relative to the non-magnetic powder, and more preferably 1 to 20 wt %, and dispersing.

In methods (1) and (2) above, the solids content concentration in the kneading step is preferably 70 to 90 wt %, and more preferably 70 to 80 wt %. The solids content concentration during dispersion is preferably 20 to 50 wt %, and more preferably 20 to 40 wt %. It is preferable for the solids content concentration in the kneading step and the dispersion step to be in the above-mentioned range since the non-magnetic powder can be dispersed well, adsorption of resin (A) onto the non-magnetic powder is good, and high dispersibility can be achieved.

The solids content referred to here means materials other than the organic solvent in the coating liquid.

Furthermore, in the kneading step and the dispersion step, in order to prevent an excessive polymerization reaction from occurring, it is also preferable to control the temperature during preparation. It is preferable to adjust the temperature of the non-magnetic coating liquid to 60° C. to 120° C., more preferably 70° C. to 110° C., and yet more preferably 80° C. to 100° C. It is preferable for the temperature during preparation to be in the above-mentioned range since an appropriate coating liquid viscosity is obtained and the dispersibility of the non-magnetic powder is good.

### Non-Magnetic Support

With regard to the non-magnetic support that can be used in the present invention, known biaxially stretched films such as polyethylene naphthalate, polyethylene terephthalate, polyamide, polyimide, polyamideimide, aromatic polyamide, and polybenzoxidazol can be used. Polyethylene naphthalate and aromatic polyamide are preferred. These supports can be subjected in advance to a corona discharge treatment, a plasma treatment, a treatment for enhancing adhesion, a thermal treatment, etc. The non-magnetic support that can be used in the present invention preferably has a surface having excellent smoothness such that its center line average surface roughness is in the range of 0.1 to 20 nm, and preferably 1 to 10 nm, for a cutoff value of 0.25 mm. Furthermore, these non-magnetic supports preferably have not only a small center line average surface roughness but also no coarse projections with a height of 1 μm or greater.

### Step of Forming a Non-Magnetic Layer by Applying a Non-Magnetic Coating Liquid Above a Non-Magnetic Support

With regard to a method for coating the non-magnetic support with the non-magnetic coating solution, it is not particularly limited and, for example, the surface of a moving non-magnetic support is coated with a magnetic layer coating solution. As coating equipment for applying the above-mentioned non-magnetic coating solution, an air doctor coater, a blade coater, a rod coater, an extrusion coater, an air knife coater, a squeegee coater, a dip coater, a reverse roll coater, a transfer roll coater, a gravure coater, a kiss coater, a cast coater, a spray coater, a spin coater, etc. can be used. With regard to these, for example, ‘Saishin Kotingu Gijutsu’ (Latest Coating Technology) (May 31, 1983) published by Sogo Gijutsu Center can be referred to.

The coated layer of the non-magnetic coating liquid thus applied is subsequently dried, thus forming a non-magnetic layer.

Step of Curing by Irradiating Non-Magnetic Layer with Radiation

In the present invention, examples of the radiation used in the step of curing by irradiating the non-magnetic layer with radiation include an electron beam and UV rays. When UV rays are used, a photopolymerization initiator is used in combination. In the case of curing with an electron beam, no polymerization initiator is required, and since the electron beam has a deep penetration depth, irradiation is preferably carried out with an electron beam in the present invention.

With regard to electron beam accelerators, there are a scanning system, a double scanning system, and a curtain beam system, and the curtain beam system is preferable since it is relatively inexpensive and gives a high output. With regard to electron beam characteristics, the acceleration voltage is 30 to 1,000 kV, and preferably 50 to 300 kV, and the absorbed dose is 0.5 to 20 Mrad, and preferably 2 to 10 Mrad. When the acceleration voltage is 30 kV or greater, the amount of energy penetrating is sufficient, and when it 300 kV or less, the energy efficiency for the polymerization is high and it is economic. The electron beam irradiation atmosphere is preferably controlled by a nitrogen purge so that the concentration of oxygen is 200 ppm or less. When the oxygen concentration is high, crosslinking and curing reactions in the vicinity of the surface are inhibited.

As a light source for the ultraviolet rays, a mercury lamp is used. A mercury lamp with a 20 to 240 W/cm lamp is used at a speed of 0.3 to 20 m/min. The distance between a substrate and the mercury lamp is usually preferably 1 to 30 cm.

As the photopolymerization initiator used for ultraviolet curing, a radical photopolymerization initiator is used. More particularly, those described in, for example, ‘Shinkobunshi Jikkengaku’ (New Polymer Experiments), Vol. 2, Chapter 6 Photo/Radiation Polymerization (Published by Kyoritsu Publishing, 1995, Ed. by the Society of Polymer Science, Japan) can be used. Specific examples thereof include acetophenone, benzophenone, anthraquinone, benzoin ethyl ether, benzil methyl ketal, benzil ethyl ketal, benzoin isobutyl ketone, hydroxydimethyl phenyl ketone, 1-hydroxycyclohexyl phenyl ketone, and 2,2-diethoxyacetophenone. The mixing ratio of the aromatic ketone is preferably 0.5 to 20 parts by weight relative to 100 parts by weight of the radiation curing compound, more preferably 2 to 15 parts by weight, and yet more preferably 3 to 10 parts by weight.

Irradiation with radiation is preferably carried out after applying and drying a non-magnetic layer. With regard to the radiation-curing equipment, conditions, etc., known equipment and conditions described in ‘UV•EB Kokagijutsu’ (UV/EB Curing Technology) (1982, published by the Sogo Gijutsu Center), ‘Teienerugi Denshisen Shosha no Oyogijutsu’ (Low Energy Electron Beam) (2000, Published by CMC), etc. can be employed.

### Magnetic Layer

The magnetic layer is now explained in detail.

In the process for producing a magnetic recording medium of the present invention, the magnetic layer is a layer in which a ferromagnetic powder is dispersed in a binder, and is a layer that is involved in magnetic recording and playback.

### Ferromagnetic Powder

The magnetic recording medium of the present invention employs a cobalt-containing ferromagnetic iron oxide or a cobalt-containing ferromagnetic alloy powder. The specific surface area of the ferromagnetic metal powder by the BET method (S_{BET}) is preferably 40 to 80 m²/g, and more preferably 50 to 70 m²/g. The crystallite size is preferably 12 to 25 nm, more preferably 13 to 22 nm, and particularly preferably 14 to 20 nm. The major axis length is preferably 0.05 to 0.25 μm, more preferably 0.07 to 0.2 μm, and yet more preferably 0.08 to 0.15 μm.

Examples of the ferromagnetic metal powder include yttrium-containing Fe, Fe—Co, Fe—Ni, and Co—Ni—Fe, and the yttrium content in the ferromagnetic metal powder is preferably 0.5 atom % to 20 atom % as the yttrium atom/Fe atom ratio Y/Fe, and more preferably 5 to 10 atom %. It is preferable if it is in such a range since it is possible to obtain good saturation magnetization for the ferromagnetic metal powder, and the magnetic properties are improved. Since the iron content is high, the magnetic properties are good, and this is preferable since good electromagnetic conversion characteristics are obtained. Furthermore, it is also possible for aluminum, silicon, sulfur, scandium, titanium, vanadium, chromium, manganese, copper, zinc, molybdenum, rhodium, palladium, tin, antimony, boron, barium, tantalum, tungsten, rhenium, gold, lead, phosphorus, lanthanum, cerium, praseodymium, neodymium, tellurium, bismuth, etc. to be present at 20 atom % or less relative to 100 atom % of iron. It is also possible for the ferromagnetic metal powder to contain a small amount of water, a hydroxide, or an oxide.

One example of a process for producing the ferromagnetic metal powder used in the present invention, into which cobalt or yttrium has been introduced, is illustrated below. For example, an iron oxyhydroxide obtained by blowing an oxidizing gas into an aqueous suspension in which a ferrous salt and an alkali have been mixed can be used as a starting material. This iron oxyhydroxide is preferably of the α-FeOOH type, and with regard to a production process therefor, there is a first production process in which a ferrous salt is neutralized with an alkali hydroxide to form an aqueous suspension of Fe(OH)₂, and an oxidizing gas is blown into this suspension to give acicular α-FeOOH. There is also a second production process in which a ferrous salt is neutralized with an alkali carbonate to form an aqueous suspension of FeCO₃, and an oxidizing gas is blown into this suspension to give spindle-shaped α-FeOOH. Such an iron oxyhydroxide is preferably obtained by reacting an aqueous solution of a ferrous salt with an aqueous solution of an alkali to give an aqueous solution containing ferrous hydroxide, and then oxidizing this with air, etc. In this case, the aqueous solution of the ferrous salt may contain an Ni salt, a salt of an alkaline earth element such as Ca, Ba, or Sr, a Cr salt, a Zn salt, etc., and by selecting these salts appropriately the particle shape (axial ratio), etc. can be adjusted.

As the ferrous salt, ferrous chloride, ferrous sulfate, etc. are preferable. As the alkali, sodium hydroxide, aqueous ammonia, ammonium carbonate, sodium carbonate, etc. are preferable. With regard to salts that can be present at the same time, chlorides such as nickel chloride, calcium chloride, barium chloride, strontium chloride, chromium chloride, and zinc chloride are preferable. In a case where cobalt is subsequently introduced into the iron, before introducing yttrium, an aqueous solution of a cobalt compound such as cobalt sulfate or cobalt chloride is mixed and stirred with a slurry of the above-mentioned iron oxyhydroxide. After the slurry of iron oxyhydroxide containing cobalt is prepared, an aqueous solution containing a yttrium compound is added to this slurry, and they are stirred and mixed.

In the present invention, neodymium, samarium, praseodymium, lanthanum, gadolinium, etc. can be introduced into the ferromagnetic metal powder as well as yttrium. They can be introduced using a chloride such as yttrium chloride, neodymium chloride, samarium chloride, praseodymium chloride, or lanthanum chloride or a nitrate salt such as neodymium nitrate or gadolinium nitrate, and they can be used in a combination of two or more types. The form of the ferromagnetic metal powder is not limited and may be any of acicular, granular, rice-grain shaped, and tabular. It is particularly preferable to use an acicular ferromagnetic metal powder.

In the present invention, a ferromagnetic hexagonal ferrite powder can be used as the ferromagnetic powder of the magnetic layer.

Examples of the ferromagnetic hexagonal ferrite include substitution products of barium ferrite, strontium ferrite, lead ferrite, and calcium ferrite, and Co substitution products. More specifically, magnetoplumbite type barium ferrite and strontium ferrite, magnetoplumbite type ferrite with a particle surface coated with a spinel magnetoplumbite type barium ferrite and strontium ferrite partially containing a spinel phase, etc., can be cited. In addition to the designated atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr may be included. In general, those to which Co—Ti, Co—Ti—Zr, Co—Ti—Zn, Ni—Ti—Zn, Nb—Zn—Co, Sb—Zn—Co, Nb—Zn, etc. have been added can be used. Characteristic impurities may be included depending on the starting material and the production process.

The particle size is preferably 10 to 200 nm as a hexagonal plate size, more preferably 20 to 100 nm. When a magnetoresistive head is used for playback, the plate size is preferably 40 nm or smaller so as to reduce noise. It is preferable if the plate size is in such a range, since stable magnetization can be expected due to the absence of thermal fluctuations. Furthermore, noise is reduced and it is suitable for high density magnetic recording.

The tabular ratio (plate size/plate thickness) is preferably 1 to 15, and more preferably 2 to 7. When it is in such a range, adequate orientation can be obtained, and noise decreases due to an absence of inter-particle stacking. The S_{BET} of a powder having a particle size within this range is usually 10 to 200 m²/g. The specific surface area substantially coincides with the value obtained by calculation using the plate size and the plate thickness.

The crystallite size is preferably 50 to 450 Å (5 to 45 nm), and more preferably 100 to 350 Å (10 to 35 nm). The plate size and the plate thickness distributions are preferably as narrow as possible. Although it is difficult, the distribution can be expressed using a numerical value by randomly measuring 500 particles on a TEM photograph of the particles. The distribution is not a regular distribution in many cases, but the standard deviation calculated with respect to the average size is preferably σ/average size=0.1 to 2.0. In order to narrow the particle size distribution, the reaction system used for forming the particles is made as homogeneous as possible, and the particles so formed are subjected to a distribution-improving treatment. For example, a method of selectively dissolving ultrafine particles in an acid solution is also known.

The coercive force (Hc) measured for the tabular ferromagnetic substance can be adjusted so as to be on the order of 500 to 5,000 Oe (39.8 to 398 kA/m). A higher Hc is advantageous for high-density recording, but it is restricted by the capacity of the recording head. It is preferably on the order of 800 to 4,000 Oe (63.7 to 318.4 kA/m), more preferably 119.4 to 278.6 kA/m (1,500 to 3,5000e). When the saturation magnetization of the head exceeds 1.4 T, it is preferably 2,000 Oe (159.2 kA/m) or higher. The Hc can be controlled by the particle size (plate size, plate thickness), the type and amount of element included, the element replacement sites, the conditions used for the particle formation reaction, etc.

The saturation magnetization (σs) is preferably 40 to 80 A·m²/kg (40 to 80 emu/g). A higher σs is preferable, but there is a tendency for it to become lower when the particles become finer. In order to improve the σs, making a composite of magnetoplumbite ferrite with spinel ferrite, selecting the types of element included and their amount, etc. are well known. It is also possible to use a W type hexagonal ferrite.

When dispersing the magnetic substance, the surface of the magnetic particles can be treated with a material that is compatible with a dispersing medium and the polymer (binder). With regard to a surface-treatment agent, an inorganic or organic compound can be used. Representative examples include oxides and hydroxides of Si, Al, P, etc., and various types of silane coupling agents and various kinds of titanium coupling agents. The amount thereof is preferably 0.1% to 10% based on the magnetic substance.

The pH of the magnetic substance is also important for dispersion. It is usually on the order of 4 to 12, and although the optimum value depends on the dispersing medium and the polymer, it is selected from on the order of 6 to 10 from the viewpoints of chemical stability and storage properties of the medium. The moisture contained in the magnetic substance also influences the dispersion. Although the optimum value depends on the dispersing medium and the polymer, it is usually 0.01% to 2.0%.

With regard to a production method for the ferromagnetic hexagonal ferrite, there is glass crystallization method (1) in which barium oxide, iron oxide, a metal oxide that replaces iron, and boron oxide, etc. as glass forming materials are mixed so as to give a desired ferrite composition, then melted and rapidly cooled to give an amorphous substance, subsequently reheated, then washed and ground to give a barium ferrite crystal powder; hydrothermal reaction method (2) in which a barium ferrite composition metal salt solution is neutralized with an alkali, and after a by-product is removed, it is heated in a liquid phase at 100° C. or higher, then washed, dried and ground to give a barium ferrite crystal powder; co-precipitation method (3) in which a barium ferrite composition metal salt solution is neutralized with an alkali, and after a by-product is removed, it is dried and treated at 1,100° C. or less, and ground to give a barium ferrite crystal powder, etc., but any production method can be used in the present invention.

Furthermore, as a ferromagnetic powder that can be used in the present invention, iron nitride particles may also be used.

The iron nitride particles that can be used in the present invention are preferably a spherical or spheroidal iron nitride-based magnetic substance comprising at least Fe and N as constituent elements. The ‘spherical’ referred to here means particles having a particle size maximum length/minimum length ratio of at least 1 but less than 2, and the ‘spheroidal’ referred to here means particles having a particle size maximum length/minimum length ratio of at least 2 but less than 4.

The spherical or ellipsoidal magnetic substance is preferably an iron nitride-based ferromagnetic powder containing Fe₁₆N₂ as a main phase. It may comprise, in addition to Fe and N atoms, an atom such as Al, Si, S, Sc, Ti, V, Cr, Cu, Y, Mo, Rh, Pd, Ag, Sn, Sb, Te, Ba, Ta, W, Re, Au, Hg, Pb, Bi, La, Ce, Pr, Nd, P, Co, Mn, Zn, Ni, Sr, B, Ge, Nb, or Zr. The content of N relative to Fe is preferably 1.0 to 20.0 atom %.

The iron nitride is preferably spherical or ellipsoidal, and the major axis length/minor axis length axial ratio of the spherical magnetic substance is preferably from not less than 1 to less than 2. The BET specific surface area (S_{BET}) is preferably 30 to 100 m²/g, and more preferably 50 to 70 m²/g. The crystallite size is preferably 12 to 25 nm, and more preferably 13 to 22 nm.

The saturation magnetization σs is preferably 50 to 200 A m²/kg (emu/g), and more preferably 70 to 150 A m²/kg (emu/g).

### Binder

In the present invention, a conventionally known thermoplastic resin, thermosetting resin, reactive resin or a mixture thereof is used as a binder of the magnetic layer.

The thermoplastic resin preferably has a glass transition temperature of −100° C. to 150° C., a number-average molecular weight of 1,000 to 200,000, and more preferably 10,000 to 100,000, and a degree of polymerization of 50 to 1,000.

Examples thereof include polymers and copolymers containing as a repeating unit vinyl chloride, vinyl acetate, vinyl alcohol, maleic acid, acrylic acid, an acrylate ester, vinylidene chloride, acrylonitrile, methacrylic acid, a methacrylate ester, styrene, butadiene, ethylene, vinyl butyral, vinyl acetal and vinyl ether; polyurethane resins; and various types of rubber resins.

Examples of the thermosetting resin and the reactive resin include phenol resins, epoxy resins, curable type polyurethane resins, urea resins, melamine resins, alkyd resins, reactive acrylic resins, formaldehyde resins, silicone resins, epoxy-polyamide resins, mixtures of a polyester resin and an isocyanate prepolymer, mixtures of a polyester polyol and a polyisocyanate, and mixtures of a polyurethane and a polyisocyanate.

Details of these resins are described in the ‘Purasuchikku Binran’ (Plastic Handbook) published by Asakura Shoten. It is also possible to use a known electron beam curable type resin in the non-magnetic layer (lower layer) or the magnetic layer (upper layer). Examples of the resin and a production method therefor are disclosed in detail in JP-A-62-256219. The above-mentioned resins can be used singly or in combination. Combinations of a polyurethane resin with at least one selected from a vinyl chloride resin, a vinyl chloride-vinyl acetate resin, a vinyl chloride-vinyl acetate-vinyl alcohol resin, a vinyl chloride-vinyl acetate-maleic anhydride copolymer, and nitrocellulose, and combinations thereof with a polyisocyanate are preferred.

Specific examples of the binder include VAGH, VYHH, VMCH, VAGF, VAGD, VROH, VYES, VYNC, VMCC, XYHL, XYSG, PKHH, PKHJ, PKHC and PKFE (manufactured by Union Carbide Corporation), MPR-TA, MPR-TA5, MPR-TAL, MPR-TSN, MPR-TMF, MPR-TS, and MPR-TM (manufactured by Nisshin Chemical Industry Co., Ltd.), 1000W, DX80, DX81, DX82, and DX83 (manufactured by Denki Kagaku Kogyo Kabushiki Kaisha), MR-110, MR-100, and 400X-110A (manufactured by Nippon Zeon Corporation), Nippollan N2301, N2302, and N₂₃₀₄ (manufactured by Nippon Polyurethane Industry Co., Ltd.), Pandex T-5105, T-R3080, and T-5201, Burnock D-400 and D-210-80, and Crisvon 6109 and 7209 (manufactured by Dainippon Ink and Chemicals, Incorporated), Vylon UR8200, UR8300, RV530, and RV280 (manufactured by Toyobo Co., Ltd.), Daiferamine 4020, 5020, 5100, 5300, 9020, 9022, and 7020 (manufactured by Dainichiseika Color & Chemicals Mfg. Co., Ltd.), MX5004 (manufactured by Mitsubishi Chemical Corp.), Sanprene SP-150 (manufactured by Sanyo Chemical Industries, Ltd.), and Saran F310 and F210 (manufactured by Asahi Kasei Corporation).

As the binder that can be used in the magnetic layer, among the above-mentioned binders, a vinyl chloride-based binder or a polyurethane-based binder is preferable, and a polyurethane containing a polar group and containing 3.5 mmol/g to 7 mmol/g of aromatic rings in the framework is particularly preferable.

Preferred examples of the polyurethane-based binder include polyester urethane, polyether urethane, polycarbonate urethane, polyether ester urethane, and acrylic polyurethane. The above-mentioned polyurethane-based binders are preferable since they have high affinity for the above-mentioned lubricant and the amount of surface lubricant can be controlled so as to be in an optimum range.

The polar group that the binder may have is preferably a sulfonate, a sulfamate, a sulfobetaine, a phosphate, a phosphonate, etc. The amount of polar group is preferably 1×10⁻⁵ eq/g to 2×10⁻⁴ eq/g.

The amount of binder, including curing agent, in the magnetic layer is preferably 10 to 25 parts by weight relative to 100 parts by weight of the ferromagnetic powder.

### Abrasive

The magnetic layer of the magnetic recording medium of the present invention preferably contains an abrasive.

An inorganic non-magnetic powder can be used as the abrasive. Examples of the inorganic non-magnetic powder include inorganic compounds such as a metal oxide, a metal carbonate, a metal sulfate, a metal nitride, a metal carbide, and a metal sulfide. As the inorganic compound, α-alumina with an α-component proportion of 90% to 100%, β-alumina, γ-alumina, silicon carbide, chromium oxide, cerium oxide, α-iron oxide (colcothar), corundum, silicon nitride, titanium carbide, titanium oxide, silicon dioxide, tin oxide, magnesium oxide, tungsten oxide, zirconium oxide, boron nitride, zinc oxide, barium sulfate, molybdenum disulfide, etc. can be used singly or in combination. Particularly preferred are α-alumina, colcothar, and chromium oxide.

When only one type of abrasive is used, the average particle size of the abrasive used in the present invention is preferably 0.05 to 0.4 μm, and more preferably 0.1 to 0.3 μm. It is preferable that particles with a particle size larger than the average particle size by 0.1 μm or more are present at a proportion of 1 to 40%, more preferably 5 to 30%, and most preferably 10 to 20%. Although the particle size of the abrasive itself affects the particle size of abrasive particles that are actually present on the surface of the magnetic layer, they are not equal to each other. The particle size of the abrasive particles present on the surface of the magnetic layer varies according to the dispersion conditions, etc. for the abrasive. Furthermore, some particles come out easily to the surface of the magnetic layer during coating and drying steps whereas it is difficult for others to come out to the surface.

Two or more abrasives having different average particle sizes may be used in combination. In this case, taking the weighted average value as the average particle size, which depends on the actual proportions used of the two or more abrasives, the particles with the average particle size and the particles with a particle size 0.1 μm or more greater than the average particle size can be set so as to be within the above-mentioned ranges.

Changing the dispersion conditions for the two abrasives can also control the particle size. For example, abrasive A is dispersed with a binder and a solvent in advance. This dispersion and abrasive B as a powder are added to a kneaded ferromagnetic metal powder that has been kneaded separately with a binder and a solvent, and the mixture is dispersed. In this way, the dispersion conditions for the abrasive A and the abrasive B can be varied. That is, the abrasive A is dispersed more strongly than the abrasive B. The tap density of the abrasive powder is preferably 0.05 to 2 g/mL, and more preferably 0.2 to 1.5 g/mL.

The water content of the abrasive powder is preferably 0.05 to 5 wt %, and more preferably 0.2 to 3 wt %. The specific surface area of the abrasive is preferably 1 to 100 m²/g, and more preferably 5 to 50 m²/g. Its oil absorption determined using DBP (dibutyl phthalate) is preferably 5 to 100 mL/100 g, and more preferably 10 to 80 mL/100 g. The specific gravity is preferably 1 to 12, and more preferably 3 to 6. The shape of the abrasive may be any one of acicular, spherical, polyhedral, and tabular. The surface of the abrasive may be coated at least partially with a compound which is different from the main component of the abrasive. Examples of the compound include Al₂O₃, SiO₂, TiO₂, ZrO₂, SnO₂, Sb₂O₃, and ZnO. In particular, the use of Al₂O₃, SiO₂, TiO₂ or ZrO₂ gives good dispersibility. These compounds may be used singly or in combination.

Specific examples of the abrasive that can be used in the magnetic layer of the present invention include Nanotite (manufactured by Showa Denko K.K.), Hit 100, Hit 82, Hit 80, Hit 70, Hit 60A, Hit 55, AKP-20, AKP-30, AKP-50, and ZA-G1 (manufactured by Sumitomo Chemical Co., Ltd.), ERC-DBM, HP-DBM, HPF-DBM, HPFX-DBM, HPS-DBM, and HPSX-DBM (manufactured by Reynolds Corp.), WA8000 and WA10000 (manufactured by Fujimi Incorporated), UB20, UB40B, and Mecanox UA (manufactured by C. Uyemura & Co., Ltd.), UA2055, UA5155, and UA5305 (manufactured by Showa Keikinzoku K.K.), G-5, Kromex M, Kromex S1, Kromex U2, Kromex U1, Kromex X10, and Kromex KX10 (manufactured by Nippon Chemical Industry Co., Ltd.), ND803, ND802, and ND801 (manufactured by Nippon Denko Co., Ltd.), F-1, F-2, and UF-500 (manufactured by Tosoh Corporation), DPN-250, DPN-250BX, DPN-245, DPN-270BX, TF100, TF-120, TF-140, DPN-550BX, and TF-180 (manufactured by Toda Kogyo Corp.), A-3 and B-3 (manufactured by Showa Mining Co., Ltd.), beta SiC and UF (manufactured by Central Glass Co., Ltd.), 13-Random Standard and β-Random Ultrafine (manufactured by Ibiden Co., Ltd.), JR401, MT-100S, MT-100T, MT-150 W, MT-500B, MT-600B, MT-100F, and MT-500HD (manufactured by Tayca Corporation), TY-50, TTO-51B, TTO-55A, TTO-55B, TTO-55C, TTO-55S, TTO-55D, SN-100, E270, and E271 (manufactured by Ishihara Sangyo Kaisha Ltd.), STT-4D, STT-30D, STT-30, STT-65C, and Y-LOP, and calcined products thereof (manufactured by Titan Kogyo Kabushiki Kaisha), FINEX-25, BF-1, BF-10, BF-20, and ST-M (manufactured by Sakai Chemical Industry Co., Ltd.), HZn and HZr3M (manufactured by Hokkai Kagaku), DEFIC-Y and DEFIC-R (manufactured by Dowa Mining Co., Ltd.), AS2BM and TiO2P25 (manufactured by Nippon Aerosil Co., Ltd.), and 100A and 500A (manufactured by Ube Industries, Ltd.).

### Additive

In the present invention, an additive may be added as necessary to the magnetic layer. As the additive, a dispersant/dispersion adjuvant, a fungicide, an antistatic agent, an antioxidant, a solvent, carbon black, and a lubricant can be cited.

As these additives, the same additives as those used for the non-magnetic layer may be used.

The type and the amount of these dispersing agents and surfactants used in the magnetic layer of the magnetic recording medium of the present invention can be changed as necessary in the magnetic layer and the non-magnetic layer. Furthermore, all or part of the additives used in the present invention may be added to any step of production of the magnetic coating liquid. There are, for example, a case in which they are mixed with a ferromagnetic powder prior to a kneading step, a case in which they are added in a kneading step of a ferromagnetic powder, a binder, and a solvent, a case in which they are added in a dispersion step, a case in which they are added after dispersion, a case in which they are added immediately prior to coating, etc.

Furthermore, carbon black may be added to the magnetic layer of the magnetic recording medium of the present invention as necessary. The carbon black that can suitably be used in the magnetic layer is the same as the carbon black that can suitably be used in the non-magnetic layer.

The types of carbon black that can be used include furnace black for rubber, thermal black for rubber, carbon black for coloring, acetylene black, etc. The carbon black of the magnetic layer should have optimized characteristics depending on desired effects, and this may be achieved by using a combination thereof.

These carbon blacks may be used singly or in combination. When carbon black is used, it is preferably used in an amount of 0.1 wt % to 30 wt % relative to the weight of the magnetic substance. Carbon black has functions of preventing static charging of the magnetic layer, reducing the coefficient of friction, imparting light-shielding properties, and improving the film strength, and the functions depend on the type of carbon black used. Accordingly, it is of course possible in the present invention to appropriately choose the type, the amount, and the combination of carbon black for the magnetic layer according to the intended purpose on the basis of the above-mentioned various properties such as the particle size, the oil absorption, the electrical conductivity, and the pH, and it is better if they are optimized for the respective layers.

### Step of Preparing Magnetic Coating Liquid

The above-mentioned components are kneaded and dispersed together with a solvent that is usually used when preparing a magnetic coating material, such as methyl ethyl ketone, dioxane, cyclohexanone, or ethyl acetate, thus giving a magnetic coating liquid, and there are no particular restrictions.

### Method for Forming Magnetic Layer

The process for producing a magnetic recording medium of the present invention comprises a step of forming a magnetic layer above a cured non-magnetic layer. The step of forming a magnetic layer is not particularly limited and may be selected appropriately from known methods.

Formation of a magnetic layer preferably comprises a step of applying and drying a magnetic coating liquid, a step of smoothing the surface by calendering, etc., and a step of irradiating with radiation, and each step may be carried out by the same method as for the non-magnetic layer described above.

### Layer Structure

In the present invention, with regard to the constitution of the magnetic recording medium, the thickness of the non-magnetic support is preferably 1 to 100 μm, and preferably 4 to 80 μm.

The thickness of the magnetic layer is preferably 0.01 to 0.5 μm, more preferably 0.05 to 0.2 μm, and yet more preferably 0.05 to 0.10 μm. When the upper layer is 0.01 μm or greater, a uniform recording layer can be formed, and when it is 0.2 μm or less, the surface is smooth and the good electromagnetic conversion characteristics can be obtained. In addition, the process for producing a magnetic recording medium of the present invention is particularly suitable for production of a magnetic recording medium with a magnetic layer of 0.10 μm or less. In accordance with the process for producing a magnetic recording medium of the present invention, an excellent non-magnetic layer can be provided, and as a result, even if a magnetic layer of 0.10 μm or less is formed, a magnetic recording medium having excellent coating strength and electromagnetic conversion characteristics and having excellent transport durability can be produced.

The thickness of the non-magnetic layer is preferably is preferably 0.5 to 3 μm, and more preferably 0.8 to 2 μm. When it is 0.5 μm or greater, the durability is excellent, and when it is 3 μm or less, the surface is smooth and the good electromagnetic conversion characteristics can be obtained. The total thickness of the upper layer and the lower layer is desirably in the range of 1/100 to 2 times the thickness of the non-magnetic support.

An undercoat layer may be provided between the non-magnetic support and the non-magnetic layer in order to improve adhesion. The thickness of the undercoat layer is 0.01 to 2 μm, and preferably 0.02 to 0.5 μm.

A backcoat layer may be provided on a surface of the non-magnetic support used in the present invention that is not coated with a non-magnetic coating liquid. The backcoat layer is usually a layer provided by coating the surface of the non-magnetic support that is not coated with the non-magnetic coating liquid with a backcoat layer-forming coating material comprising particulate components such as an abrasive and an antistatic agent and a binder dispersed in an organic solvent. In addition, an adhesive layer may be provided on the surfaces of the non-magnetic support that are to be coated with the non-magnetic coating material and the backcoat layer-forming coating material. When the backcoat layer is provided on the surface of the non-magnetic support on the opposite side to the surface where the non-magnetic layer is provided, the thickness of the backcoat layer is suitably 0.1 to 2 μm, and preferably 0.3 to 1.0 μm. These undercoat and backcoat layers may employ known layers.

The magnetic recording medium of the present invention preferably has a surface with extremely good smoothness such that the surface center line average roughness is 0.1 to 4.0 nm for a cutoff value of 0.25 mm, and more preferably 1 to 3 nm. As a method therefor, a magnetic layer formed by selecting a specific ferromagnetic powder and binder as described above is subjected to the above-mentioned calendering treatment. With regard to calendering conditions, the calendar roll temperature is preferably in the range of 60° C. to 100° C., more preferably in the range of 70° C. to 100° C., and particularly preferably in the range of 80° C. to 100° C., and the pressure is preferably in the range of 9.8 to 49 MPa (100 to 500 kg/cm²), more preferably in the range of 19.6 to 44.1 MPa (200 to 450 kg/cm²), and particularly preferably in the range of 29.4 to 39.2 MPa (300 to 400 kg/cm²). As described above, irradiation with radiation is preferably carried out after coating, drying, and calendering the non-magnetic layer and the magnetic layer. A layered material thus cured is cut into a desired shape.

In accordance with the present invention, there can be provided a magnetic recording medium having excellent coating strength and electromagnetic conversion characteristics and having excellent transport durability.

### EXAMPLES

The present invention is explained further in detail below by reference to Examples of the present invention, but the present invention is not limited to the Examples. Unless otherwise specified, ‘parts’ described below means ‘parts by weight’, and ‘%’ means ‘wt %’.

### Example 1

### Preparation of Magnetic Coating Liquid

| | | |
|---|---|---|
| Ferromagnetic alloy powder | 100 | parts |
| (composition: Fe/Co/Al/Y = 57/30/7/6; surface treatment agent: Al₂O₃, Y₂O₃; Hc 190 kA/m; | | |
| crystallite size 13.7 nm; major axis length 0.11 μm; acicular ratio 8; BET | | |
| specific surface area 47 m²/g; σs 153 A · m²/kg) | | |
| Polyurethane resin | 12 | parts |
| (UR8200: sulfonic acid group-containing polyurethane resin, manufactured by | | |
| Toyobo Co., Ltd.) | | |
| Vinyl chloride resin | 6 | parts |
| (MR110: sulfonic acid group-containing vinyl chloride resin, manufactured by Nippon | | |
| Zeon Corporation) | | |
| Monobiphenyl phosphate | 3 | parts |
| 100 parts of the magnetic substance was ground in a nitrogen gas-flushed | | |
| open kneader for 10 minutes, the polyurethane resin, the vinyl chloride resin, and | | |
| monobiphenyl phosphate were subsequently added thereto and kneaded with 60 | | |
| parts of cyclohexanone for 60 minutes, and subsequently | | |
| abrasive (Al₂O₃, particle size 0.3 μm) | 2 | parts |
| carbon black (particle size 40 μm) | 2 | parts, and |
| methyl ethyl ketone/cyclohexanone = 1/1 | 200 | parts |
| were added and the mixture was dispersed in a sand mill for 120 minutes. To this, | | |
| butyl stearate | 2 | parts and |
| stearic acid | 1 | part |
| were added, and methyl ethyl ketone/cyclohexanone solvent at a ratio by weight of | | |
| 1/1 was added so that the solids content concentration was 16%. | | |
| To this was added | | |
| trifunctional low molecular weight polyisocyanate compound | 6 | parts |
| (Coronate 3041, manufactured by Nippon Polyurethane Industry Co., Ltd.), and | | |
| the mixture was stirred for a further 20 minutes and filtered using a filter having an | | |
| average pore size of 1 μm to give a magnetic layer (upper layer) magnetic coating | | |
| liquid. | | |

### Preparation of Non-Magnetic Coating Liquid

| | | |
|---|---|---|
| α-Fe₂O₃ | 85 | parts |
| (average particle size 0.07 μm, surface treatment | | |
| with Al₂O₃ and SiO₂, pH 6.5 to 8.0) | | |
| and | | |
| carbon black | 15 | parts |
| (DBP oil absorption 120 mL/100 g, pH 8, BET | | |
| specific surface area 250 m²/g, volatile | | |
| content 1.5%) | | |
| were ground in an open kneader for 10 minutes, | | |
| and then kneaded for 60 minutes with | | |
| resin A shown in Table 1 | 15 | parts |
| SO₃Na-containing polyurethane solution | 5 | parts (solids |
| | | content) |
| compound B shown in Table 1 | 12 | parts, and |
| cyclohexanone | 40 | parts |
| following which | | |
| methyl ethyl ketone/cyclohexanone = 1/1 | 200 | parts |
| was added, and the mixture was dispersed in a | | |
| sand mill for 120 minutes. To this were added | | |
| butyl stearate | 2 | parts |
| stearic acid | 1 | part |
| methyl ethyl ketone | 50 | parts, and |
| dipentaerythritol hexaacrylate | 50 | parts |
| and after stirring the mixture for a further 20 | | |
| minutes it was filtered using a filter having an | | |
| average pore size of 1 μm to give a non- | | |
| magnetic (lower layer) non-magnetic coating liquid. | | |

A surface of a 10 μm thick aramid support was coated by means of a wire-wound bar with a sulfonic acid-containing polyester resin as an adhesive layer so that the dry thickness would be 0.1 μm. Subsequently, it was coated with the non-magnetic coating liquid so that the dry thickness would be 1 μm.

Following this it was cured by irradiation with an electron beam so that the absorbed dose was 10 Mrad at an acceleration voltage of 175 kV and a beam current of 10 mA, thus forming a non-magnetic layer.

Using reverse roll, the magnetic coating liquid was applied onto the non-magnetic layer thus formed so that the dry thickness would be 0.1 μm. Before the magnetic coating material had dried, magnetic field alignment was carried out using a 0.5 T (5,000 G) Co magnet and a 0.4 T (4,000 G) solenoid magnet, and the coating was then subjected to a calendar treatment employing a metal roll-metal roll-metal roll-metal roll-metal roll-metal roll-metal roll combination (speed 100 m/min, line pressure 300 kg/cm, temperature 90° C.). It was further subjected to a thermal curing treatment at 70° C. for 24 hours and cut into a width of 6.35 mm to give a magnetic tape. It was then slit to a width of 3.8 mm.

### Examples 2 to 4

Magnetic recording media were produced by preparing non-magnetic coating liquids in the same manner as in Example 1 except that resin (A) was changed as shown in Table 1.

### Example 5

### Preparation of Non-Magnetic Coating Liquid

| | | |
|---|---|---|
| α-Fe₂O₃ | 85 | parts |
| (average particle size 0.07 μm, surface treatment | | |
| with Al₂O₃ and SiO₂, pH 6.5 to 8.0) | | |
| and | | |
| carbon black | 15 | parts |
| (DBP oil absorption 120 mL/100 g, pH 8, BET | | |
| specific surface area 250 m²/g, volatile | | |
| content 1.5%) | | |
| were ground in an open kneader for 10 minutes, | | |
| and then kneaded for 60 minutes with | | |
| resin A shown in Table 1 | 15 | parts |
| SO₃Na-containing polyurethane solution | 5 | parts (solids |
| | | content), and |
| cyclohexanone | 40 | parts, |
| following which | | |
| compound B shown in Table 1 | 12 | parts and |
| methyl ethyl ketone/cyclohexanone = 6/4 | 200 | parts |
| were added, and the mixture was dispersed in | | |
| a sand mill for 120 minutes. To this were added | | |
| butyl stearate | 2 | parts |
| stearic acid | 1 | part |
| methyl ethyl ketone | 50 | parts, and |
| dipentaerythritol hexaacrylate | 50 | parts |
| and after stirring the mixture for a further 20 | | |
| minutes it was filtered using a filter | | |
| having an average pore size of 1 μm | | |
| to give a non-magnetic coating liquid. | | |

A magnetic recording medium was prepared in the same manner as in Example 1 except that the non-magnetic coating liquid above was used.

### Example 6

### Preparation of Non-Magnetic Coating Liquid

| | | |
|---|---|---|
| α-Fe₂O₃ | 85 | parts |
| (average particle size 0.07 μm, surface treatment | | |
| with Al₂O₃ and SiO₂, pH 6.5 to 8.0) | | |
| and | | |
| carbon black | 15 | parts |
| (DBP oil absorption 120 mL/100 g, pH 8, BET | | |
| specific surface area 250 m²/g, volatile | | |
| content 1.5%) | | |
| were ground in an open kneader for 10 minutes, | | |
| and then kneaded for 60 minutes with | | |
| resin A shown in Table 1 | 15 | parts |
| SO₃Na-containing polyurethane solution | 5 | parts (solids |
| | | content), and |
| cyclohexanone | 40 | parts, |
| following which | | |
| methyl ethyl ketone/cyclohexanone = 6/4 | 200 | parts |
| was added, and the mixture was dispersed in a | | |
| sand mill for 120 minutes. To this were added | | |
| compound B shown in Table 1 | 12 | parts |
| butyl stearate | 2 | parts |
| stearic acid | 1 | part |
| methyl ethyl ketone | 50 | parts, and |
| dipentaerythritol hexaacrylate | 50 | parts |
| and after stirring the mixture for a further 20 | | |
| minutes it was filtered using a filter | | |
| having an average pore size of 1 μm | | |
| to give a non-magnetic coating liquid. | | |

A magnetic recording medium was prepared in the same manner as in Example 1 except that the non-magnetic coating liquid above was used.

### Examples 7 to 15

Magnetic recording media were produced in the same manner as in Example 1 except that compound (B) was changed as shown in Table 1.

### Comparative Example 1

A non-magnetic coating liquid was prepared in the same manner as in Example 1 except that, instead of resin (A), the SO₃Na-containing polyurethane solution, and compound (B) of the non-magnetic coating liquid in Example 1, 15 parts of a vinyl chloride copolymer (TBO246 (electron beam-curing vinyl chloride resin), average degree of polymerization 310, epoxy content 3 wt %, S content 0.6 wt %, acrylic content 6 per molecule, Tg 60° C., manufactured by Toyobo Co., Ltd.) and 15 parts of a polyester polyurethane resin (TBO242 (electron beam-curing polyurethane resin), phosphorus compound—hydroxy-containing polyester polyurethane, Mn (GPC) 26,000, acrylic content 6 per molecule, Tg −20° C., manufactured by Toyobo Co., Ltd.) were used, and a magnetic recording medium was produced using the above.

### Comparative Example 2

A magnetic recording medium was produced by preparing a non-magnetic coating liquid in the same manner as in Example 1 except that compound (B) was not used.

### Comparative Example 3

A magnetic recording medium was produced as follows using the magnetic coating liquid and the non-magnetic coating liquid prepared in Example 1.

A surface of a 10 μm thick aramid support was coated by means of a wire-wound bar with a sulfonic acid-containing polyester resin as an adhesive layer so that the dry thickness would be 0.1 μm. Subsequently, it was coated with the non-magnetic coating liquid so that the dry thickness would be 1 μm, and immediately thereafter the magnetic coating liquid was applied by simultaneous multilayer coating using reverse roll so that the dry thickness would be 0.1 μm. Before the magnetic coating material had dried, magnetic field alignment was carried out using a 0.5 T (5,000 G) Co magnet and a 0.4 T (4,000 G) solenoid magnet, and the coating was then subjected to a calender treatment employing a metal roll-metal roll-metal roll-metal roll-metal roll-metal roll-metal roll combination (speed 100 m/min, line pressure 300 kg/cm, temperature 90° C.). The surface of the magnetic layer of the tape thus obtained was irradiated with an electron beam so that the absorbed dose was 10 Mrad at an acceleration voltage of 175 kV and a beam current of 10 mA. It was then slit to a width of 3.8 mm.

### Comparative Example 4

A magnetic recording medium was produced in the same manner as in Comparative Example 3 except that the magnetic coating liquid and the non-magnetic coating liquid prepared in Example 5 were used.

### Measurement Methods

### (1) Coating Smoothness

The number of projections having a size of 10 nm or greater was determined by scanning an area of 30 μm×30 μm using a Nanoscope II manufactured by Digital Instruments at a tunnel current of 10 nA and a bias voltage of 400 mV. It was expressed as a relative value, where the value for Comparative Example 1 was 100.

### (2) Electromagnetic Conversion Characteristics

Output, output decrease: a signal with a frequency of 4.7 MHz was recorded at 23° C. and 50% RH on the tape obtained, and played back.

It was expressed as a relative value, where the value for the playback output of Comparative Example 1 was 0 dB.

### (3) Coating Durability

The surface of the magnetic layer was made to contact an AlTiC pole in an environment at 50° C. and 20% RH with a load of 40 g (T1), and 1,000 passes were repeated at a speed of 8 mm/sec; the surface of the magnetic layer was examined using a differential interference optical microscope and evaluated using the rankings below.

Excellent: no scratches at all.
Good: a few scratches were observed.
Poor: scratches were observed, and the magnetic layer was scraped off.

TABLE 1

| | Non-magnetic layer | | | | Medium evaluation results | | |
|---|---|---|---|---|---|---|---|
| | | | Step of | | | Electromagnetic | |
| | | Compound | adding | Coating | Coating | conversion | |
| | Resin (A) | (B) | compound (B) | method | smoothness | characteristics | Durability |
| Ex. 1 | Resin A-1 | Compound | During | Successive | 60 | 1.5 | Excellent |
| | | B-1 | kneading | multilayer | | | |
| Ex. 2 | Resin A-2 | Compound | During | Successive | 64 | 1.3 | Excellent |
| | | B-1 | kneading | multilayer | | | |
| Ex. 3 | Resin A-3 | Compound | During | Successive | 68 | 1.2 | Excellent |
| | | B-1 | kneading | multilayer | | | |
| Ex. 4 | Resin A-1 | Compound | During | Successive | 55 | 1.8 | Excellent |
| | | B-2 | kneading | multilayer | | | |
| Ex. 5 | Resin A-1 | Compound | During | Successive | 70 | 1.1 | Excellent |
| | | B-1 | dispersion | multilayer | | | |
| Ex. 6 | Resin A-1 | Compound | After | Successive | 78 | 0.8 | Good |
| | | B-1 | dispersion | multilayer | | | |
| Ex. 7 | Resin A-1 | Compound | During | Successive | 60 | 1.5 | Excellent |
| | | B-1 | kneading | multilayer | | | |
| Ex. 8 | Resin A-1 | Compound | During | Successive | 68 | 1.1 | Good |
| | | B-3 | kneading | multilayer | | | |
| Ex. 9 | Resin A-1 | Compound | During | Successive | 65 | 1.3 | Good |
| | | B-4 | kneading | multilayer | | | |
| Ex. 10 | Resin A-1 | Compound | During | Successive | 45 | 2.5 | Excellent |
| | | B-5 | kneading | multilayer | | | |
| Ex. 11 | Resin A-1 | Compound | During | Successive | 40 | 3.0 | Excellent |
| | | B-6 | kneading | multilayer | | | |
| Ex. 12 | Resin A-1 | Compound | During | Successive | 55 | 1.8 | Excellent |
| | | B-7 | kneading | multilayer | | | |
| Ex. 13 | Resin A-1 | Compound | During | Successive | 65 | 1.3 | Excellent |
| | | B-8 | kneading | multilayer | | | |
| Ex. 14 | Resin A-1 | Compound | During | Successive | 70 | 1.2 | Good |
| | | B-9 | kneading | multilayer | | | |
| Ex. 15 | Resin A-1 | Compound | During | Successive | 70 | 1.2 | Excellent |
| | | B-10 | kneading | multilayer | | | |
| Comp. Ex. 1 | Resin A-4 | — | — | Successive | 100 | 0.0 | Good |
| | | | | multilayer | | | |
| Comp. Ex. 2 | Resin A-1 | — | — | Successive | 180 | −3.0 | Poor |
| | | | | multilayer | | | |
| Comp. Ex. 3 | Resin A-1 | Compound | During | Simultaneous | 110 | −0.7 | Poor |
| | | B-1 | kneading | multilayer | | | |
| Comp. Ex. 4 | Resin A-1 | Compound | After | Simultaneous | 130 | −1.2 | Poor |
| | | B-1 | dispersion | multilayer | | | |

Resin (A) and compound (B) used in Table 1 are as follows.

Resin A-1: OH group-containing vinyl chloride copolymer (molecular weight 25,000, OH group content 3×10⁻⁴ eq/g, SO₃K content 1×10⁻⁴ eq/g)
Resin A-2: OH group-containing polyurethane resin (molecular weight 35,000, OH group content 3×10⁻⁴ eq/g, SO₃Na content 1×10⁻⁴ eq/g)
Resin A-3: amino group-containing vinyl chloride copolymer (molecular weight 25,000, amino group content 3×10⁻⁴ eq/g, SO₃Na content 1×10⁻⁴ eq/g)
Resin A-4: radiation curing vinyl chloride copolymer (molecular weight 25,000, acryloyl group content 3×10⁻⁴ eq/g, SO₃K content 1×10⁻⁴ eq/g)
Compound B-1: isocyanatoethyl methacrylate
Compound B-2: isocyanatoethyl acrylate
Compound B-3: 2-methacryloyloxyethoxyethyl isocyanate
Compound B-4: 3-methacryloyloxypropoxyethyl isocyanate
Compound B-5: 1,1-bis(acryloyloxymethyl)ethyl isocyanate
Compound B-6: 1,3-diacryloyloxy-2-acryloyloxymethyl-2-propyl isocyanate
Compound B-7: methacryloyl isocyanate
Compound B-8: Karenz MOI-BP, monomer in which isocyanate group is blocked by 3,5-dimethylpyrazole, manufactured by Showa Denko K.K.
Compound B-9: Karenz MOI-BM, monomer in which isocyanate group is blocked by methyl ethyl ketone oxime, manufactured by Showa Denko K.K.
Compound B-10: Karenz MOI-BP ethylene oxide adduct (n=1), manufactured by Showa Denko K.K.

Compounds B-1 to B-10 are shown below.

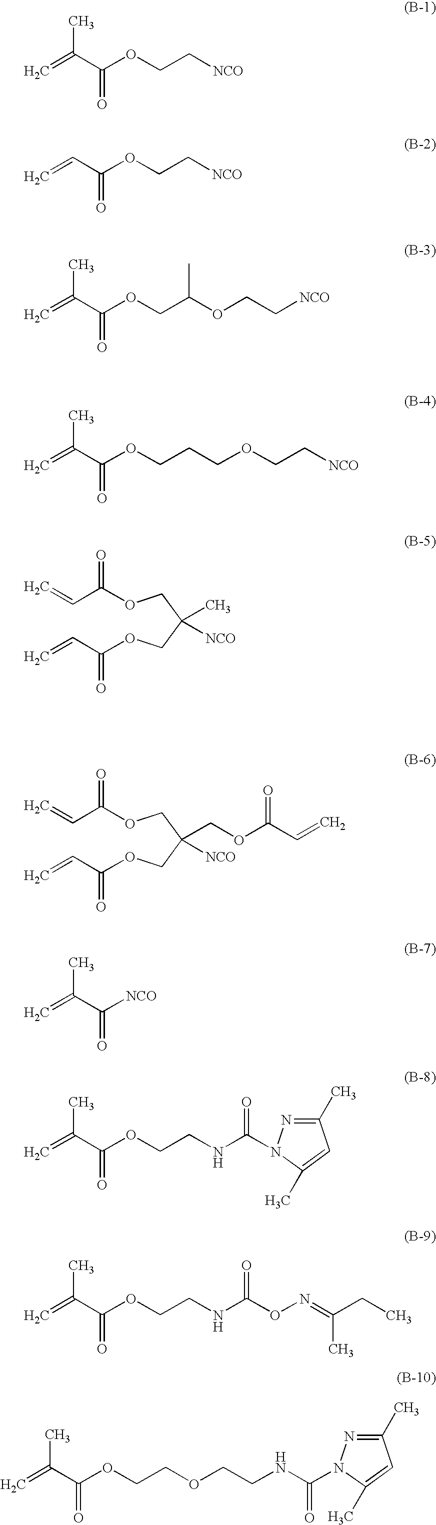

What is claimed is:

1. A process for producing a magnetic recording medium, the process comprising in sequence:
a step of forming a non-magnetic layer by applying a non-magnetic coating liquid above a non-magnetic support;
a step of curing the non-magnetic layer by irradiation with radiation; and
a step of forming a magnetic layer above the cured non-magnetic layer;
the non-magnetic coating liquid comprising a resin having a hydroxy group and/or an amino group and a compound having an isocyanato group and/or a substituent represented by Formula (1) below and a radiation curing functional group, 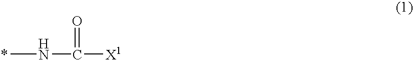
(in Formula (1) above, X¹ is Formula (2) or Formula (3) below, and * denotes a bonding position).

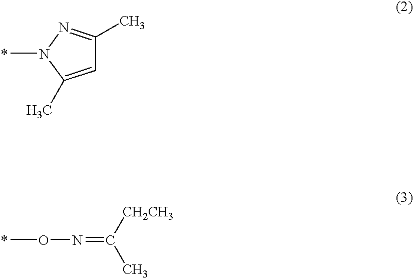

2. The process for producing a magnetic recording medium according to claim 1, wherein the radiation curing functional group is an acryloyl group, a methacryloyl group, an acryloyloxy group, or a methacryloyloxy group.

3. The process for producing a magnetic recording medium according to claim 1, wherein the compound having an isocyanato group and/or a substituent represented by Formula (1) above and a radiation curing functional group is represented by Formula (4) below,
R¹-X²-R² (4)
(in Formula (4) above, R¹ denotes an acryloyl group, a methacryloyl group, an acryloyloxy group, or a methacryloyloxy group, X² denotes a single bond, an alkylene group having 1 to 18 carbons, or a substituent represented by Formula (5) or Formula (6) below, and R² denotes an isocyanate group or a substituent represented by Formula (1) above) 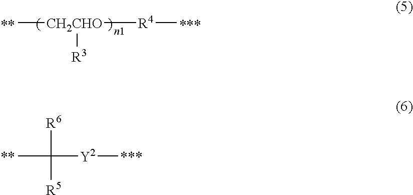
(in Formula (5) and Formula (6) above, R³ denotes a hydrogen atom or a methyl group, R⁴ denotes an alkylene group having 1 to 6 carbons, R⁵ and R⁶ independently denote an acryloyl group, a methacryloyl group, an acryloyloxy group, a methacryloyloxy group, a hydrogen atom, or a methyl group, Y² denotes a single bond or an alkylene group having 1 to 6 carbons, n1 is an integer of 1 to 20, ** denotes a position of bonding to R¹, and *** denotes a position of bonding to R²).

4. The process for producing a magnetic recording medium according to claim 1, wherein the non-magnetic coating liquid comprises a magnetic powder and the non-magnetic powder has an average particle size of at least 5 nm but no greater than 2 μm.

5. The process for producing a magnetic recording medium according to claim 1, wherein the non-magnetic coating liquid comprises a magnetic powder and the non-magnetic powder has a pH of at least 2 but no greater than 11.

6. The process for producing a magnetic recording medium according to claim 1, wherein the non-magnetic powder is titanium dioxide and/or α-iron oxide.

7. The process for producing a magnetic recording medium according to claim 1, wherein the non-magnetic layer comprises carbon black.

8. The process for producing a magnetic recording medium according to claim 1, wherein the resin having a hydroxy group and/or an amino group has a total hydroxy group and amino group content of 50 to 1,000 μeq/g.

9. The process for producing a magnetic recording medium according to claim 1, wherein the resin having a hydroxy group and/or an amino group has a molecular weight of 10,000 to 100,000.

10. The process for producing a magnetic recording medium according to claim 1, wherein the resin having a hydroxy group and/or an amino group comprises at least one type of polar group selected from the group consisting of —SO₃M, —SO₄M, —PO(OM)₂, —OPO(OM)₂, >NSO₃M, and >NRSO₃M (here, M is hydrogen or an alkali metal such as Na or K, and R is an alkylene group), and has a total content of said polar group of at least 10 μeq/g but no greater than 500 μg/eq.

11. The process for producing a magnetic recording medium according to claim 1, wherein the resin having a hydroxy group and/or an amino group is added in an amount of 5 to 30 wt % relative to the solids content of the non-magnetic coating liquid.

12. The process for producing a magnetic recording medium according to claim 1, wherein the compound having an isocyanato group and/or a substituent represented by Formula (1) above and a radiation curing functional group has a molecular weight of at least 90 but no greater than 10,000.

13. The process for producing a magnetic recording medium according to claim 1, wherein the non-magnetic coating liquid is prepared by
a step of kneading and dispersing the resin having a hydroxy group and/or an amino group, the compound having an isocyanato group and/or a substituent represented by Formula (1) above and a radiation curing functional group, and a non-magnetic powder, or
a step of adding to a non-magnetic powder the resin having a hydroxy group and/or an amino group and kneading, and then adding the compound having an isocyanato group and/or a substituent represented by Formula (1) above and a radiation curing functional group and dispersing.

14. The process for producing a magnetic recording medium according to claim 13, wherein the solids content concentration in the kneading step is 70 to 90 wt %.

15. The process for producing a magnetic recording medium according to claim 13, wherein the solids content concentration in the dispersing step is 20 to 50 wt %.

16. The process for producing a magnetic recording medium according to claim 13, wherein the temperature of the non-magnetic coating liquid in the kneading step and the dispersing step is 60° C. to 120° C.

17. The process for producing a magnetic recording medium according to claim 1, wherein the step of curing the non-magnetic layer by irradiation with radiation is a step of irradiating with an electron beam and/or a step of irradiating with UV rays.
